(19) United States
(12) Patent Application Publication
(10) Pub. No.: US 2021/0245118 A1
(43) Pub. Date: Aug. 12, 2021

(54) UFB-CONTAINING LIQUID PRODUCTION APPARATUS AND UFB-CONTAINING LIQUID PRODUCTION METHOD

(71) Applicant: CANON KABUSHIKI KAISHA, Tokyo (JP)

(72) Inventors: Akitoshi Yamada, Kanagawa (JP); Masahiko Kubota, Tokyo (JP); Akira Yamamoto, Kanagawa (JP); Yoshiyuki Imanaka, Kanagawa (JP); Yumi Yanai, Kanagawa (JP); Hiroyuki Ishinaga, Tokyo (JP); Teruo Ozaki, Kanagawa (JP); Toshio Kashino, Kanagawa (JP); Ikuo Nakazawa, Kanagawa (JP)

(21) Appl. No.: 17/167,253

(22) Filed: Feb. 4, 2021

(30) Foreign Application Priority Data
Feb. 12, 2020 (JP) 2020-021424

(51) Int. Cl. B01F 3/04; B01F 3/22; B01F 5/10

(52) U.S. Cl. CPC B01F 3/04531; B01F 3/04503; B01F 3/2261; B01F 3/2223; B01F 2215/0032; B01F 5/102; B01F 2003/0468; B01F 2215/0077; B01F 3/2284

(57) ABSTRACT

Provided is a UFB-containing liquid production apparatus that can efficiently produce a UFB-containing liquid with a UFB generation unit. The UFB-containing liquid production apparatus includes: a gas dissolution unit that produces a gas-dissolved liquid by dissolving a gas into a liquid supplied from a liquid supply unit; a UFB generation unit that generates UFBs in the flowing-in gas-dissolved liquid; and a circulation path that supplies the gas-dissolved liquid to the UFB generation unit and supplies a UFB-containing liquid produced by the UFB generation unit to the liquid supply unit. In the circulation path, there is provided a micro-bubble reduction unit that reduces an amount of micro-bubbles contained in the gas-dissolved liquid to flow into the UFB generation unit.

### BACKGROUND OF THE INVENTION

### Field of the Invention

The present invention relates to a UFB-containing liquid production apparatus and a UFB-containing liquid production method that produce a UFB-containing liquid containing ultrafine bubbles.

### Description of the Related Art

In recent years, usefulness of an ultrafine bubble (hereinafter, referred to as UFB)-containing liquid that contains UFBs having diameters of less than 1.0 μm has been confirmed in various fields.

Japanese Patent Laid-Open No. 2019-042732 discloses an apparatus that generates UFBs with a UFB generation unit in a liquid supplied from a liquid supply tank and then outputs a UFB-containing liquid to a liquid collection container. Moreover, Japanese Patent Laid-Open No. 2019-042732 discloses a circulation path that causes the liquid outputted to the liquid collection container to flow back to the liquid supply tank. The UFB content concentration can be increased by repeatedly supplying the UFB-containing liquid to the UFB generation unit through the circulation path.

However, in the apparatus disclosed in Japanese Patent Laid-Open No. 2019-042732, the liquid supplied to the UFB generation unit sometimes contains bubbles (micro-bubbles (MBs), millimeter-bubbles, and the like) having diameters equal to or greater than a micrometer size. In the case where many micro-bubbles as described above are supplied to the UFB generation unit, there is a possibility that the UFBs generated in the UFB generation unit are taken into the MBs and sufficient UFB generation efficiency cannot be obtained.

### SUMMARY OF THE INVENTION

An object of the present invention is to provide a UFB-containing liquid production apparatus and a UFB-containing liquid production method that can efficiently produce a UFB-containing liquid with a UFB generation unit.

The present invention provides a UFB-containing liquid production apparatus including: a gas dissolution unit that produces a gas-dissolved liquid by dissolving a gas into a liquid supplied from a liquid supply unit; a UFB generation unit that generates UFBs in the gas-dissolved liquid flowing into the UFB generation unit; a circulation path that supplies the gas-dissolved liquid produced by the gas dissolution unit to the UFB generation unit and supplies a UFB-containing liquid produced by the UFB generation unit to the liquid supply unit; and a micro-bubble reduction unit that is provided in the circulation path and that reduces an amount of micro-bubbles contained in the gas-dissolved liquid to flow into the UFB generation unit.

According to the present invention, the UFB generation unit can efficiently produce the UFB-containing liquid.

Further features of the present invention will become apparent from the following description of exemplary embodiments with reference to the attached drawings.

### BRIEF DESCRIPTION OF THE DRAWINGS

FIG. 1 is a diagram illustrating an example of a UFB generating apparatus;

FIG. 2 is a schematic configuration diagram of a pre-processing unit;

FIGS. 3A and 3B are a schematic configuration diagram of a dissolving unit and a diagram for describing the dissolving states in a liquid;

FIG. 4 is a schematic configuration diagram of a T-UFB generating unit;

FIGS. 5A and 5B are diagrams for describing details of a heating element;

FIGS. 6A and 6B are diagrams for describing the states of film boiling on the heating element;

FIGS. 7A to 7D are diagrams illustrating the states of generation of UFBs caused by expansion of a film boiling bubble;

FIGS. 8A to 8C are diagrams illustrating the states of generation of UFBs caused by shrinkage of the film boiling bubble;

FIGS. 9A to 9C are diagrams illustrating the states of generation of UFBs caused by reheating of the liquid;

FIGS. 10A and 10B are diagrams illustrating the states of generation of UFBs caused by shock waves made by disappearance of the bubble generated by the film boiling;

FIGS. 11A and 11B are views illustrating how the UFBs are generated by a change in saturation solubility of the liquid;

FIGS. 12A to 12C are views illustrating configuration examples of a post-treatment unit;

FIG. 13 is a block diagram illustrating a configuration of a control system in the embodiment;

FIG. 14 is a diagram illustrating a configuration of a UFB-containing liquid production apparatus in a first embodiment;

FIG. 15 is a diagram illustrating a configuration in a first modified example of the first embodiment;

FIG. 16 is a diagram illustrating a configuration of a UFB-containing liquid production apparatus in a second embodiment;

FIG. 17 is a diagram illustrating a configuration in a first modified example of the second embodiment;

FIG. 18 is a diagram illustrating a configuration in a second modified example of the second embodiment;

FIG. 19 is a diagram illustrating a configuration in a third modified example of the second embodiment;

FIG. 20 is a diagram illustrating a configuration in a fourth modified example of the second embodiment;

FIG. 21 is a diagram illustrating a configuration in a fifth modified example of the second embodiment;

FIG. 22 is a diagram illustrating a configuration in a sixth modified example of the second embodiment;

FIG. 23 is a diagram illustrating a configuration in a third embodiment;

FIG. 24 is a diagram illustrating a configuration in a fourth embodiment;

FIGS. 25A and 25B are explanatory views illustrating a state of MBs in an MB flow-in prevention unit;

FIGS. 26A to 26C are views illustrating a UFB generation process in T-UFB;

FIGS. 27A and 27B are views illustrating effects of MBs in UFB generation; and

FIG. 28 is a diagram illustrating a configuration of a conventional UFB-containing liquid production apparatus.

DESCRIPTION OF THE EMBODIMENTS

### «Configuration of UFB Generating Apparatus»

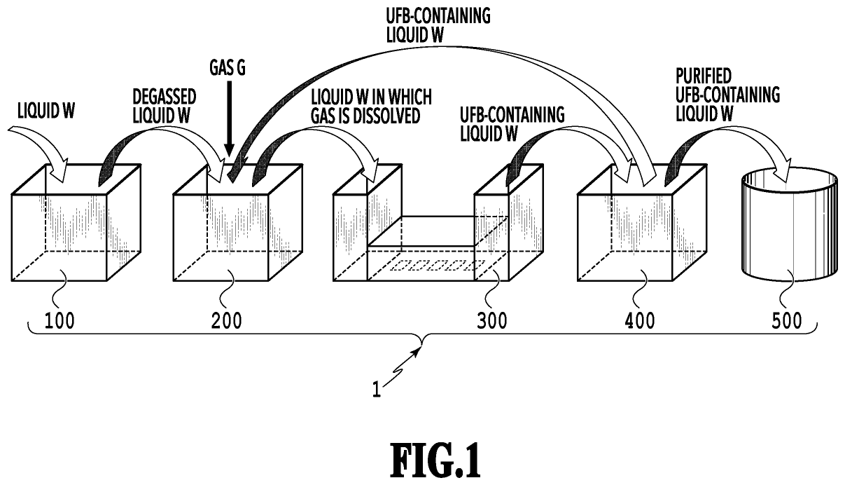

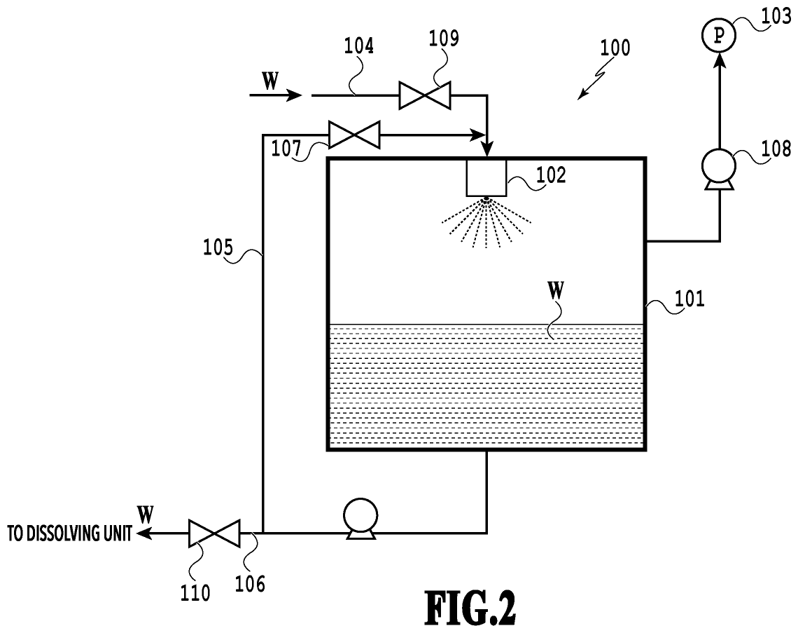

FIG. 1 is a diagram illustrating an example of a UFB generating apparatus applicable to the present invention. A UFB generating apparatus 1 of this embodiment includes a pre-processing unit 100, dissolving unit 200, a T-UFB generating unit 300, a post-processing unit 400, and a collecting unit 500. Each unit performs unique processing on a liquid W such as tap water supplied to the pre-processing unit 100 in the above order, and the thus-processed liquid W is collected as a T-UFB-containing liquid by the collecting unit 500. Functions and configurations of the units are described below. Although details are described later, UFBs generated by utilizing the film boiling caused by rapid heating are referred to as thermal-ultrafine bubbles (T-UFBs) in this specification. FIG. 2 is a schematic configuration diagram of the pre-processing unit 100. The pre-processing unit 100 of this embodiment performs a degassing treatment on the supplied liquid W. The pre-processing unit 100 mainly includes a degassing container 101, a shower head 102, a depressurizing pump 103, a liquid introduction passage 104, a liquid circulation passage 105, and a liquid discharge passage 106. For example, the liquid W such as tap water is supplied to the degassing container 101 from the liquid introduction passage 104 through a valve 109. In this process, the shower head 102 provided in the degassing container 101 sprays a mist of the liquid W in the degassing container 101. The shower head 102 is for prompting the gasification of the liquid W; however, a centrifugal and the like may be used instead as the mechanism for producing the gasification prompt effect.

When a certain amount of the liquid W is reserved in the degassing container 101 and then the depressurizing pump 103 is activated with all the valves closed, already-gasified gas components are discharged, and gasification and discharge of gas components dissolved in the liquid W are also prompted. In this process, the internal pressure of the degassing container 101 may be depressurized to around several hundreds to thousands of Pa (1.0 Torr to 10.0 Torr) while checking a manometer 108. The gases to be removed by the pre-processing unit 100 includes nitrogen, oxygen, argon, carbon dioxide, and so on, for example.

The above-described degassing processing can be repeatedly performed on the same liquid W by utilizing the liquid circulation passage 105. Specifically, the shower head 102 is operated with the valve 109 of the liquid introduction passage 104 and a valve 110 of the liquid discharge passage 106 closed and a valve 107 of the liquid circulation passage 105 opened. This allows the liquid W reserved in the degassing container 101 and degassed once to be resprayed in the degassing container 101 from the shower head 102. In addition, with the depressurizing pump 103 operated, the gasification processing by the shower head 102 and the degassing processing by the depressurizing pump 103 are repeatedly performed on the same liquid W. Every time the above processing utilizing the liquid circulation passage 105 is performed repeatedly, it is possible to decrease the gas components contained in the liquid W in stages. Once the liquid W degassed to a desired purity is obtained, the liquid W is transferred to the dissolving unit 200 through the liquid discharge passage 106 with the valve 110 opened.

FIG. 2 illustrates the degassing unit 100 that depressurizes the gas part to gasify the solute; however, the method of degassing the solution is not limited thereto. For example, a heating and boiling method for boiling the liquid W to gasify the solute may be employed, or a film degassing method for increasing the interface between the liquid and the gas using hollow fibers. A SEPAREL series (produced by DIC corporation) is commercially supplied as the degassing module using the hollow fibers. The SEPAREL series uses poly(4-methylpentene-1) (PMP) for the raw material of the hollow fibers and is used for removing air bubbles from ink and the like mainly supplied for a piezo head. In addition, two or more of an evacuating method, the heating and boiling method, and the film degassing method may be used together.

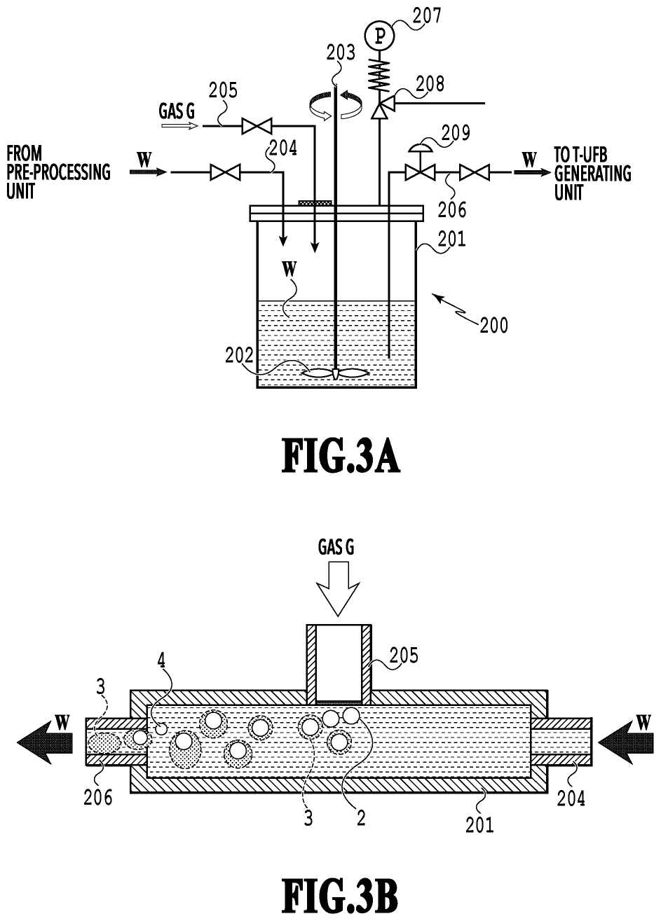

FIGS. 3A and 3B are a schematic configuration diagram of the dissolving unit 200 and a diagram for describing the dissolving states in the liquid. The dissolving unit 200 is a unit for dissolving a desired gas into the liquid W supplied from the pre-processing unit 100. The dissolving unit 200 of this embodiment mainly includes a dissolving container 201, a rotation shaft 203 provided with a rotation plate 202, a liquid introduction passage 204, a gas introduction passage 205, a liquid discharge passage 206, and a pressurizing pump 207.

The liquid W supplied from the pre-processing unit 100 is supplied and reserved into the dissolving container 201 through the liquid introduction passage 204. Meanwhile, a gas G is supplied to the dissolving container 201 through the gas introduction passage 205.

Once predetermined amounts of the liquid W and the gas G are reserved in the dissolving container 201, the pressurizing pump 207 is activated to increase the internal pressure of the dissolving container 201 to about 0.5 MPa. A safety valve 208 is arranged between the pressurizing pump 207 and the dissolving container 201. With the rotation plate 202 in the liquid rotated via the rotation shaft 203, the gas G supplied to the dissolving container 201 is transformed into air bubbles, and the contact area between the gas G and the liquid W is increased to prompt the dissolution into the liquid W. This operation is continued until the solubility of the gas G reaches almost the maximum saturation solubility. In this case, a unit for decreasing the temperature of the liquid may be provided to dissolve the gas as much as possible. When the gas is with low solubility, it is also possible to increase the internal pressure of the dissolving container 201 to 0.5 MPa or higher. In this case, the material and the like of the container need to be the optimum for safety sake.

Once the liquid W in which the components of the gas G are dissolved at a desired concentration is obtained, the liquid W is discharged through the liquid discharge passage 206 and supplied to the T-UFB generating unit 300. In this process, a back-pressure valve 209 adjusts the flow pressure of the liquid W to prevent excessive increase of the pressure during the supplying.

FIG. 3B is a diagram schematically illustrating the dissolving states of the gas G put in the dissolving container 201. An air bubble 2 containing the components of the gas G put in the liquid W is dissolved from a portion in contact with the liquid W. The air bubble 2 thus shrinks gradually, and a gas-dissolved liquid 3 then appears around the air bubble 2. Since the air bubble 2 is affected by the buoyancy, the air bubble 2 may be moved to a position away from the center of the gas-dissolved liquid 3 or be separated out from the gas-dissolved liquid 3 to become a residual air bubble 4. Specifically, in the liquid W to be supplied to the T-UFB generating unit 300 through the liquid discharge passage 206, there is a mix of the air bubbles 2 surrounded by the gas-dissolved liquids 3 and the air bubbles 2 and the gas-dissolved liquids 3 separated from each other.

The gas-dissolved liquid 3 in the drawings means “a region of the liquid W in which the dissolution concentration of the gas G mixed therein is relatively high.” In the gas components actually dissolved in the liquid W, the concentration of the gas components in the gas-dissolved liquid 3 is the highest at a portion surrounding the air bubble 2. In a case where the gas-dissolved liquid 3 is separated from the air bubble 2 the concentration of the gas components of the gas-dissolved liquid 3 is the highest at the center of the region, and the concentration is continuously decreased as away from the center. That is, although the region of the gas-dissolved liquid 3 is surrounded by a broken line in FIG. 3 for the sake of explanation, such a clear boundary does not actually exist. In addition, in the present invention, a gas that cannot be dissolved completely may be accepted to exist in the form of an air bubble in the liquid.

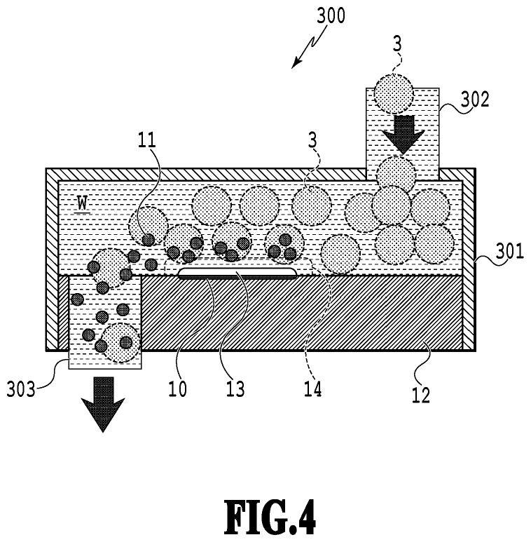

FIG. 4 is a schematic configuration diagram of the T-UFB generating unit 300. The T-UFB generating unit 300 mainly includes a chamber 301, a liquid introduction passage 302, and a liquid discharge passage 303. The flow from the liquid introduction passage 302 to the liquid discharge passage 303 through the chamber 301 is formed by a not-illustrated flow pump. Various pumps including a diaphragm pump, a gear pump, and a screw pump may be employed as the flow pump. In in the liquid W introduced from the liquid introduction passage 302, the gas-dissolved liquid 3 of the gas G put by the dissolving unit 200 is mixed.

An element substrate 12 provided with a heating element 10 is arranged on a bottom section of the chamber 301. With a predetermined voltage pulse applied to the heating element 10, a bubble 13 generated by the film boiling (hereinafter, also referred to as a film boiling bubble 13) is generated in a region in contact with the heating element 10. Then, an ultrafine bubble (UFB) 11 containing the gas G is generated caused by expansion and shrinkage of the film boiling bubble 13. As a result, a UFB-containing liquid W containing many UFBs 11 is discharged from the liquid discharge passage 303.

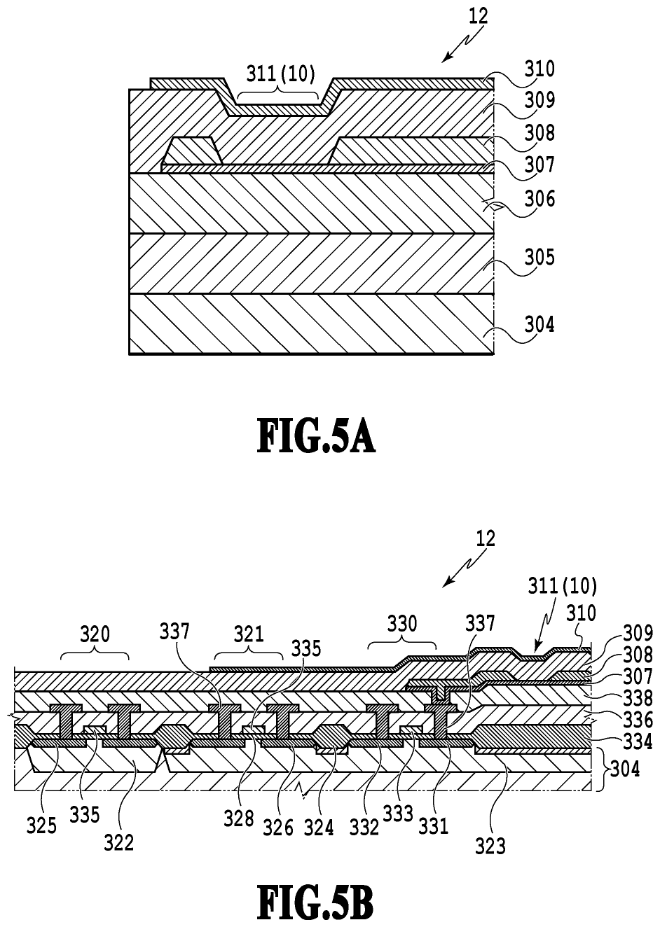

FIGS. 5A and 5B are diagrams for illustrating a detailed configuration of the heating element 10. FIG. 5A illustrates a closeup view of the heating element 10, and FIG. 5B illustrates a cross-sectional view of a wider region of the element substrate 12 including the heating element 10.

As illustrated in FIG. 5A, in the element substrate 12 of this embodiment, a thermal oxide film 305 as a heat-accumulating layer and an interlaminar film 306 also served as a heat-accumulating layer are laminated on a surface of a silicon substrate 304. An SiO₂ film or an SiN film may be used as the interlaminar film 306. A resistive layer 307 is formed on a surface of the interlaminar film 306, and a wiring 308 is partially formed on a surface of the resistive layer 307. An Al-alloy wiring of Al, Al—Si, Al—Cu, or the like may be used as the wiring 308. A protective layer 309 made of an SiO₂ film or an Si₃N₄ film is formed on surfaces of the wiring 308, the resistive layer 307, and the interlaminar film 306.

A cavitation-resistant film 310 for protecting the protective layer 309 from chemical and physical impacts due to the heat evolved by the resistive layer 307 is formed on a portion and around the portion on the surface of the protective layer 309, the portion corresponding to a heat-acting portion 311 that eventually becomes the heating element 10. A region on the surface of the resistive layer 307 in which the wiring 308 is not formed is the heat-acting portion 311 in which the resistive layer 307 evolves heat. The heating portion of the resistive layer 307 on which the wiring 308 is not formed functions as the heating element (heater) 10. As described above, the layers in the element substrate 12 are sequentially formed on the surface of the silicon substrate 304 by a semiconductor production technique, and the heat-acting portion 311 is thus provided on the silicon substrate 304.

The configuration illustrated in the drawings is an example, and various other configurations are applicable. For example, a configuration in which the laminating order of the resistive layer 307 and the wiring 308 is opposite, and a configuration in which an electrode is connected to a lower surface of the resistive layer 307 (so-called a plug electrode configuration) are applicable. In other words, as described later, any configuration may be applied as long as the configuration allows the heat-acting portion 311 to heat the liquid for generating the film boiling in the liquid.

FIG. 5B is an example of a cross-sectional view of a region including a circuit connected to the wiring 308 in the element substrate 12. An N-type well region 322 and a P-type well region 323 are partially provided in a top layer of the silicon substrate 304, which is a P-type conductor. A P-MOS 320 is formed in the N-type well region 322 and an N-MOS 321 is formed in the P-type well region 323 by introduction and diffusion of impurities by the ion implantation and the like in the general MOS process.

The P-MOS 320 includes a source region 325 and a drain region 326 formed by partial introduction of N-type or P-type impurities in a top layer of the N-type well region 322, a gate wiring 335, and so on. The gate wiring 335 is deposited on a part of a top surface of the N-type well region 322 excluding the source region 325 and the drain region 326, with a gate insulation film 328 of several hundreds of A in thickness interposed between the gate wiring 335 and the top surface of the N-type well region 322.

The N-MOS 321 includes the source region 325 and the drain region 326 formed by partial introduction of N-type or P-type impurities in a top layer of the P-type well region 323, the gate wiring 335, and so on. The gate wiring 335 is deposited on a part of a top surface of the P-type well region 323 excluding the source region 325 and the drain region 326, with the gate insulation film 328 of several hundreds of Å in thickness interposed between the gate wiring 335 and the top surface of the P-type well region 323. The gate wiring 335 is made of polysilicon of 3000 Å to 5000 Å in thickness deposited by the CVD method. A C-MOS logic is constructed with the P-MOS 320 and the N-MOS 321.

In the P-type well region 323, an N-MOS transistor 330 for driving an electrothermal conversion element (heating resistance element) is formed on a portion different from the portion including the N-MOS 321. The N-MOS transistor 330 includes a source region 332 and a drain region 331 partially provided in the top layer of the P-type well region 323 by the steps of introduction and diffusion of impurities, a gate wiring 333, and so on. The gate wiring 333 is deposited on a part of the top surface of the P-type well region 323 excluding the source region 332 and the drain region 331, with the gate insulation film 328 interposed between the gate wiring 333 and the top surface of the P-type well region 323.

In this example, the N-MOS transistor 330 is used as the transistor for driving the electrothermal conversion element. However, the transistor for driving is not limited to the N-MOS transistor 330, and any transistor may be used as long as the transistor has a capability of driving multiple electrothermal conversion elements individually and can implement the above-described fine configuration. Although the electrothermal conversion element and the transistor for driving the electrothermal conversion element are formed on the same substrate in this example, those may be formed on different substrates separately.

An oxide film separation region 324 is formed by field oxidation of 5000 Å to 10000 Å in thickness between the elements, such as between the P-MOS 320 and the N-MOS 321 and between the N-MOS 321 and the N-MOS transistor 330. The oxide film separation region 324 separates the elements. A portion of the oxide film separation region 324 corresponding to the heat-acting portion 311 functions as a heat-accumulating layer 334, which is the first layer on the silicon substrate 304.

An interlayer insulation film 336 including a PSG film, a BPSG film, or the like of about 7000 Å in thickness is formed by the CVD method on each surface of the elements such as the P-MOS 320, the N-MOS 321, and the N-MOS transistor 330. After the interlayer insulation film 336 is made flat by heat treatment, an Al electrode 337 as a first wiring layer is formed in a contact hole penetrating through the interlayer insulation film 336 and the gate insulation film 328. On surfaces of the interlayer insulation film 336 and the Al electrode 337, an interlayer insulation film 338 including an SiO₂ film of 10000 Å to 15000 Å in thickness is formed by a plasma CVD method. On the surface of the interlayer insulation film 338, a resistive layer 307 including a TaSiN film of about 500 Å in thickness is formed by a co-sputter method on portions corresponding to the heat-acting portion 311 and the N-MOS transistor 330. The resistive layer 307 is electrically connected with the Al electrode 337 near the drain region 331 via a through-hole formed in the interlayer insulation film 338. On the surface of the resistive layer 307, the wiring 308 of Al as a second wiring layer for a wiring to each electrothermal conversion element is formed. The protective layer 309 on the surfaces of the wiring 308, the resistive layer 307, and the interlayer insulation film 338 includes an SiN film of 3000 Å in thickness formed by the plasma CVD method. The cavitation-resistant film 310 deposited on the surface of the protective layer 309 includes a thin film of about 2000 Å in thickness, which is at least one metal selected from the group consisting of Ta, Fe, Ni, Cr, Ge, Ru, Zr, Ir, and the like. Various materials other than the above-described TaSiN such as TaN, CrSiN, TaAl, WSiN, and the like can be applied as long as the material can generate the film boiling in the liquid.

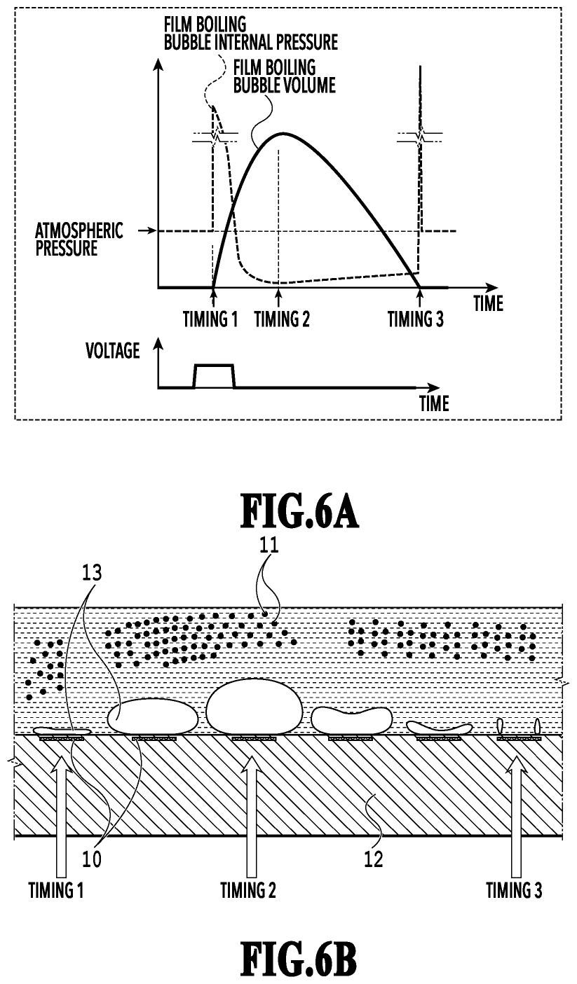

FIGS. 6A and 6B are diagrams illustrating the states of the film boiling when a predetermined voltage pulse is applied to the heating element 10. In this case, the case of generating the film boiling under atmospheric pressure is described. In FIG. 6A, the horizontal axis represents time. The vertical axis in the lower graph represents a voltage applied to the heating element 10, and the vertical axis in the upper graph represents the volume and the internal pressure of the film boiling bubble 13 generated by the film boiling. On the other hand, FIG. 6B illustrates the states of the film boiling bubble 13 in association with timings 1 to 3 shown in FIG. 6A. Each of the states is described below in chronological order. The UFBs 11 generated by the film boiling as described later are mainly generated near a surface of the film boiling bubble 13. The states illustrated in FIG. 6B are the states where the UFBs 11 generated by the generating unit 300 are resupplied to the dissolving unit 200 through the circulation route, and the liquid containing the UFBs 11 is resupplied to the liquid passage of the generating unit 300, as illustrated in FIG. 1.

Before a voltage is applied to the heating element 10, the atmospheric pressure is substantially maintained in the chamber 301. Once a voltage is applied to the heating element 10, the film boiling is generated in the liquid in contact with the heating element 10, and a thus-generated air bubble (hereinafter, referred to as the film boiling bubble 13) is expanded by a high pressure acting from inside (timing 1). A bubbling pressure in this process is expected to be around 8 to 10 MPa, which is a value close to a saturation vapor pressure of water.

The time for applying a voltage (pulse width) is around 0.5 μsec to 10.0 μsec, and the film boiling bubble 13 is expanded by the inertia of the pressure obtained in timing 1 even after the voltage application. However, a negative pressure generated with the expansion is gradually increased inside the film boiling bubble 13, and the negative pressure acts in a direction to shrink the film boiling bubble 13. After a while, the volume of the film boiling bubble 13 becomes the maximum in timing 2 when the inertial force and the negative pressure are balanced, and thereafter the film boiling bubble 13 shrinks rapidly by the negative pressure.

In the disappearance of the film boiling bubble 13, the film boiling bubble 13 disappears not in the entire surface of the heating element 10 but in one or more extremely small regions. For this reason, on the heating element 10, further greater force than that in the bubbling in timing 1 is generated in the extremely small region in which the film boiling bubble 13 disappears (timing 3).

The generation, expansion, shrinkage, and disappearance of the film boiling bubble 13 as described above are repeated every time a voltage pulse is applied to the heating element 10, and new UFBs 11 are generated each time.

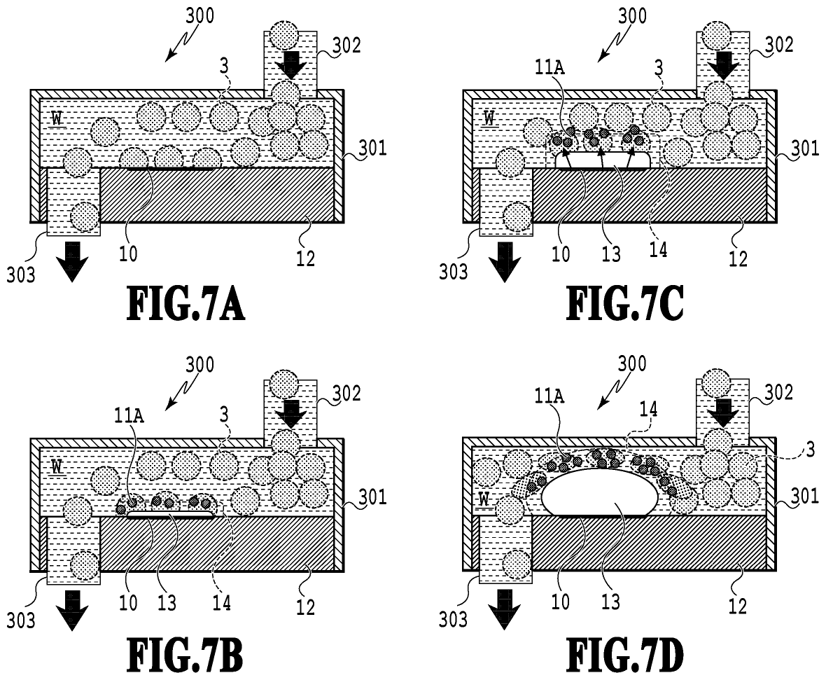

The states of generation of the UFBs 11 in each process of the generation, expansion, shrinkage, and disappearance of the film boiling bubble 13 are further described in detail with reference to FIGS. 7A to 10B.

FIGS. 7A to 7D are diagrams schematically illustrating the states of generation of the UFBs 11 caused by the generation and the expansion of the film boiling bubble 13. FIG. 7A illustrates the state before the application of a voltage pulse to the heating element 10. The liquid W in which the gas-dissolved liquids 3 are mixed flows inside the chamber 301.

FIG. 7B illustrates the state where a voltage is applied to the heating element 10, and the film boiling bubble 13 is evenly generated in almost all over the region of the heating element 10 in contact with the liquid W. When a voltage is applied, the surface temperature of the heating element 10 rapidly increases at a speed of 10° C/μsec. The film boiling occurs at a time point when the temperature reaches almost 300° C., and the film boiling bubble 13 is thus generated.

Thereafter, the surface temperature of the heating element 10 keeps increasing to around 600 to 800° C. during the pulse application, and the liquid around the film boiling bubble 13 is rapidly heated as well. In FIG. 7B, a region of the liquid that is around the film boiling bubble 13 and to be rapidly heated is indicated as a not-yet-bubbling high temperature region 14. The gas-dissolved liquid 3 within the not-yet-bubbling high temperature region 14 exceeds the thermal dissolution limit and is vaporized to become the UFB. The thus-vaporized air bubbles have diameters of around 10 nm to 100 nm and large gas-liquid interface energy. Thus, the air bubbles float independently in the liquid W without disappearing in a short time. In this embodiment, the air bubbles generated by the thermal action from the generation to the expansion of the film boiling bubble 13 are called first UFBs 11A.

FIG. 7C illustrates the state where the film boiling bubble 13 is expanded. Even after the voltage pulse application to the heating element 10, the film boiling bubble 13 continues expansion by the inertia of the force obtained from the generation thereof, and the not-yet-bubbling high temperature region 14 is also moved and spread by the inertia. Specifically, in the process of the expansion of the film boiling bubble 13, the gas-dissolved liquid 3 within the not-yet-bubbling high temperature region 14 is vaporized as a new air bubble and becomes the first UFB 11A.

FIG. 7D illustrates the state where the film boiling bubble 13 has the maximum volume. As the film boiling bubble 13 is expanded by the inertia, the negative pressure inside the film boiling bubble 13 is gradually increased along with the expansion, and the negative pressure acts to shrink the film boiling bubble 13. At a time point when the negative pressure and the inertial force are balanced, the volume of the film boiling bubble 13 becomes the maximum, and then the shrinkage is started.

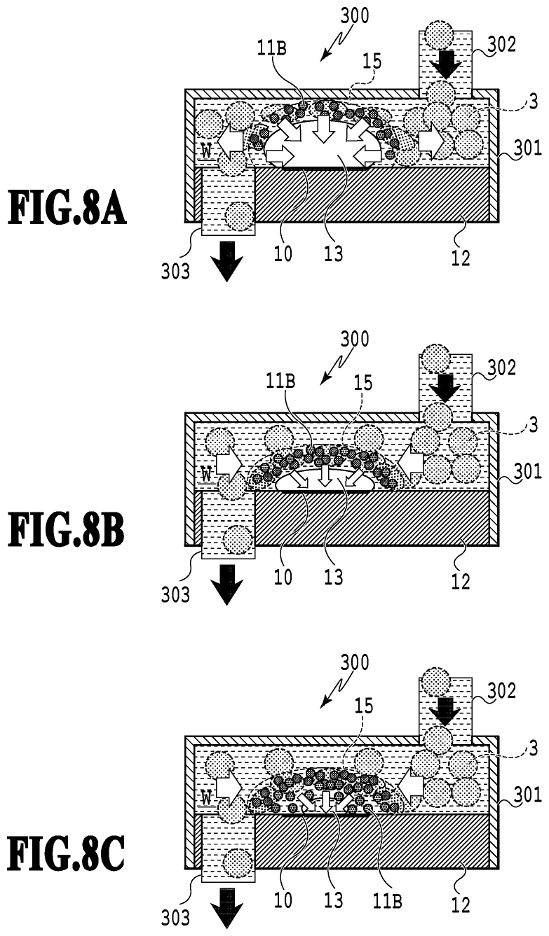

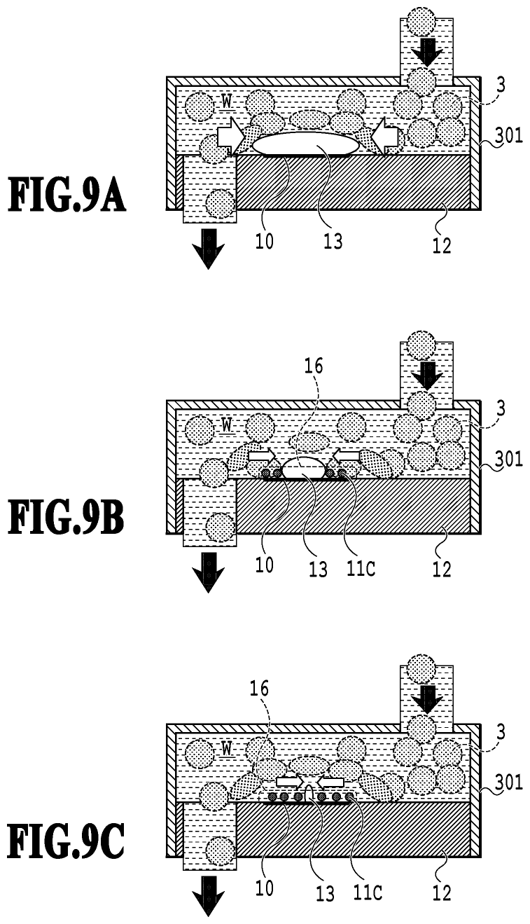

In the shrinking stage of the film boiling bubble 13, there are UFBs generated by the processes illustrated in FIGS. 8A to 8C (second UFBs 11B) and UFBs generated by the processes illustrated in FIGS. 9A to 9C (third UFBs 11C). It is considered that these two processes are made simultaneously.

FIGS. 8A to 8C are diagrams illustrating the states of generation of the UFBs 11 caused by the shrinkage of the film boiling bubble 13. FIG. 8A illustrates the state where the film boiling bubble 13 starts shrinking. Although the film boiling bubble 13 starts shrinking, the surrounding liquid W still has the inertial force in the expansion direction. Because of this, the inertial force acting in the direction of going away from the heating element 10 and the force going toward the heating element 10 caused by the shrinkage of the film boiling bubble 13 act in a surrounding region extremely close to the film boiling bubble 13, and the region is depressurized. The region is indicated in the drawings as a not-yet-bubbling negative pressure region 15.

The gas-dissolved liquid 3 within the not-yet-bubbling negative pressure region 15 exceeds the pressure dissolution limit and is vaporized to become an air bubble. The thus-vaporized air bubbles have diameters of about 100 nm and thereafter float independently in the liquid W without disappearing in a short time. In this embodiment, the air bubbles vaporized by the pressure action during the shrinkage of the film boiling bubble 13 are called the second UFBs 11B.

FIG. 8B illustrates a process of the shrinkage of the film boiling bubble 13. The shrinking speed of the film boiling bubble 13 is accelerated by the negative pressure, and the not-yet-bubbling negative pressure region 15 is also moved along with the shrinkage of the film boiling bubble 13. Specifically, in the process of the shrinkage of the film boiling bubble 13, the gas-dissolved liquids 3 within a part over the not-yet-bubbling negative pressure region 15 are precipitated one after another and become the second UFBs 11B.

FIG. 8C illustrates the state immediately before the disappearance of the film boiling bubble 13. Although the moving speed of the surrounding liquid W is also increased by the accelerated shrinkage of the film boiling bubble 13, a pressure loss occurs due to a flow passage resistance in the chamber 301. As a result, the region occupied by the not-yet-bubbling negative pressure region 15 is further increased, and a number of the second UFBs 11B are generated.

FIGS. 9A to 9C are diagrams illustrating the states of generation of the UFBs by reheating of the liquid W during the shrinkage of the film boiling bubble 13. FIG. 9A illustrates the state where the surface of the heating element 10 is covered with the shrinking film boiling bubble 13.

FIG. 9B illustrates the state where the shrinkage of the film boiling bubble 13 has progressed, and a part of the surface of the heating element 10 comes in contact with the liquid W. In this state, there is heat left on the surface of the heating element 10, but the heat is not high enough to cause the film boiling even if the liquid W comes in contact with the surface. A region of the liquid to be heated by coming in contact with the surface of the heating element 10 is indicated in the drawings as a not-yet-bubbling reheated region 16. Although the film boiling is not made, the gas-dissolved liquid 3 within the not-yet-bubbling reheated region 16 exceeds the thermal dissolution limit and is vaporized. In this embodiment, the air bubbles generated by the reheating of the liquid W during the shrinkage of the film boiling bubble 13 are called the third UFBs 11C.

FIG. 9C illustrates the state where the shrinkage of the film boiling bubble 13 has further progressed. The smaller the film boiling bubble 13, the greater the region of the heating element 10 in contact with the liquid W, and the third UFBs 11C are generated until the film boiling bubble 13 disappears.

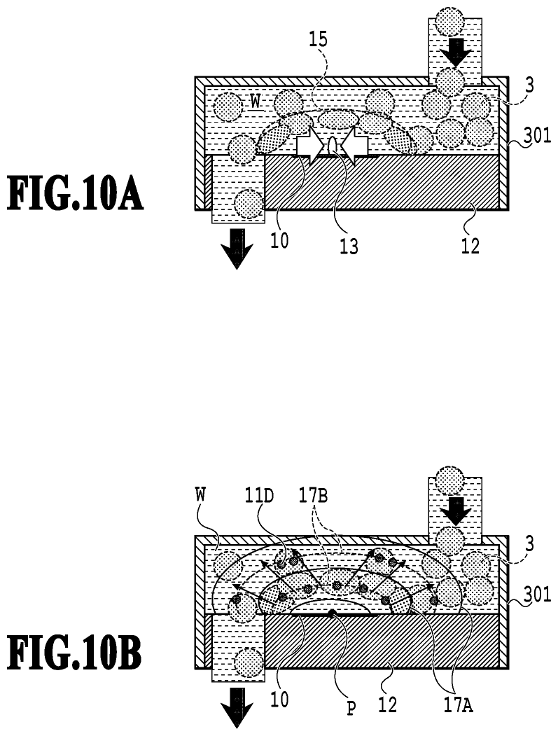

FIGS. 10A and 10B are diagrams illustrating the states of generation of the UFBs caused by an impact from the disappearance of the film boiling bubble 13 generated by the film boiling (that is, a type of cavitation). FIG. 10A illustrates the state immediately before the disappearance of the film boiling bubble 13. In this state, the film boiling bubble 13 shrinks rapidly by the internal negative pressure, and the not-yet-bubbling negative pressure region 15 surrounds the film boiling bubble 13.

FIG. 10B illustrates the state immediately after the film boiling bubble 13 disappears at a point P. When the film boiling bubble 13 disappears, acoustic waves ripple concentrically from the point P as a starting point due to the impact of the disappearance. The acoustic wave is a collective term of an elastic wave that is propagated through anything regardless of gas, liquid, and solid. In this embodiment, compression waves of the liquid W, which are a high pressure surface 17A and a low pressure surface 17B of the liquid W, are propagated alternately.

In this case, the gas-dissolved liquid 3 within the not-yet-bubbling negative pressure region 15 is resonated by the shock waves made by the disappearance of the film boiling bubble 13, and the gas-dissolved liquid 3 exceeds the pressure dissolution limit and the phase transition is made in timing when the low pressure surface 17B passes therethrough. Specifically, a number of air bubbles are vaporized in the not-yet-bubbling negative pressure region 15 simultaneously with the disappearance of the film boiling bubble 13. In this embodiment, the air bubbles generated by the shock waves made by the disappearance of the film boiling bubble 13 are called fourth UFBs 11D.

The fourth UFBs 11D generated by the shock waves made by the disappearance of the film boiling bubble 13 suddenly appear in an extremely short time (1 μS or less) in an extremely narrow thin film-shaped region. The diameter is sufficiently smaller than that of the first to third UFBs, and the gas-liquid interface energy is higher than that of the first to third UFBs. For this reason, it is considered that the fourth UFBs 11D have different characteristics from the first to third UFBs 11A to 11C and generate different effects.

Additionally, the fourth UFBs 11D are evenly generated in many parts of the region of the concentric sphere in which the shock waves are propagated, and the fourth UFBs 11D evenly exist in the chamber 301 from the generation thereof. Although many first to third UFBs already exist in the timing of the generation of the fourth UFBs 11D, the presence of the first to third UFBs does not affect the generation of the fourth UFBs 11D greatly. It is also considered that the first to third UFBs do not disappear due to the generation of the fourth UFBs 11D.

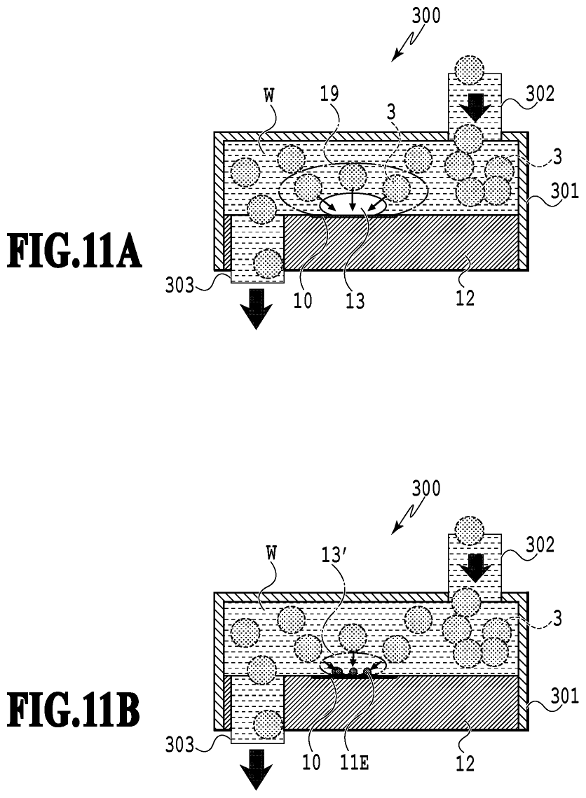

FIGS. 11A and 11B are views illustrating how the UFBs are generated by change in saturation solubility of the liquid W. FIG. 11A illustrates a state where the film-boiling bubble 13 is generated. The liquid W around the film-boiling bubble 13 is heated with the generation of the film-boiling bubble 13 and a high-temperature region 19 with a higher temperature than other regions is formed around the film-boiling bubble 13. The higher the temperature of the liquid is, the lower the saturation solubility of the liquid W is. Accordingly, the saturation solubility in the high-temperature region 19 is lower than that in the other regions and the high-temperature region 19 is in a supersaturated state where phase transition to gas tends to occur. Then, the gas-dissolved liquid 3 in the supersaturated state as described above undergoes phase transition by coming into contact with the film-boiling bubble 13 and the gas separates by turning into the UFBs. In FIGS. 11A and 11B, the arrows indicate a direction of the separation of the gas-dissolved liquid 3. In the embodiment, bubbles generated by the change in the saturation solubility around the film-boiling bubble 13 are referred to as fifth UFBs 11E.

FIG. 11B illustrates a state where the film-boiling bubble 13 has disappeared. The fifth UFBs 11E generated by coming into contact with the film-boiling bubble 13 are drawn toward the heating element 10 with the disappearance of the film-boiling bubble 13 and a region 13′ that has been occupied by the film-boiling bubble 13 is filled with the liquid W. The UFBs that are not dissolved into the liquid W again among the separated UFBs remain as the fifth UFBs 11E.

As described above, it is expected that the UFBs 11 are generated in the multiple stages from the generation to the disappearance of the film boiling bubble 13 by the heat generation of the heating element 10. The first UFBs 11A, the second UFBs 11B, and the third UFBs 11C are generated near the surface of the film boiling bubble generated by the film boiling. In this case, near means a region within about 20 μm from the surface of the film boiling bubble. The fourth UFBs 11D are generated in a region through which the shock waves are propagated when the air bubble disappears. Although the above example illustrates the stages to the disappearance of the film boiling bubble 13, the way of generating the UFBs is not limited thereto. For example, with the generated film boiling bubble 13 communicating with the atmospheric air before the bubble disappearance, the UFBs can be generated also if the film boiling bubble 13 does not reach the disappearance.

Next, remaining properties of the UFBs are described. The higher the temperature of the liquid, the lower the dissolution properties of the gas components, and the lower the temperature, the higher the dissolution properties of the gas components. In other words, the phase transition of the dissolved gas components is prompted and the generation of the UFBs becomes easier as the temperature of the liquid is higher. The temperature of the liquid and the solubility of the gas are in the inverse relationship, and the gas exceeding the saturation solubility is transformed into air bubbles and appeared in the liquid as the liquid temperature increases.

Therefore, when the temperature of the liquid rapidly increases from normal temperature, the dissolution properties are decreased without stopping, and the generation of the UFBs starts. The thermal dissolution properties are decreased as the temperature increases, and a number of the UFBs are generated.

Conversely, when the temperature of the liquid decreases from normal temperature, the dissolution properties of the gas are increased, and the generated UFBs are more likely to be liquefied. However, such temperature is sufficiently lower than normal temperature. Additionally, since the once generated UFBs have a high internal pressure and large gas-liquid interface energy even when the temperature of the liquid decreases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the first UFBs 11A described with FIGS. 7A to 7C and the third UFBs 11C described with FIGS. 9A to 9C can be described as UFBs that are generated by utilizing such thermal dissolution properties of gas.

On the other hand, in the relationship between the pressure and the dissolution properties of liquid, the higher the pressure of the liquid, the higher the dissolution properties of the gas, and the lower the pressure, the lower the dissolution properties. In other words, the phase transition to the gas of the gas-dissolved liquid dissolved in the liquid is prompted and the generation of the UFBs becomes easier as the pressure of the liquid is lower. Once the pressure of the liquid becomes lower than normal pressure, the dissolution properties are decreased instantly, and the generation of the UFBs starts. The pressure dissolution properties are decreased as the pressure decreases, and a number of the UFBs are generated.

Conversely, when the pressure of the liquid increases to be higher than normal pressure, the dissolution properties of the gas are increased, and the generated UFBs are more likely to be liquefied. However, such pressure is sufficiently higher than the atmospheric pressure. Additionally, since the once generated UFBs have a high internal pressure and large gas-liquid interface energy even when the pressure of the liquid increases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the second UFBs 11B described with FIGS. 8A to 8C and the fourth UFBs 11D described with FIGS. 10A to 10C can be described as UFBs that are generated by utilizing such pressure dissolution properties of gas.

Those first to fourth UFBs generated by different causes are described individually above; however, the above-described generation causes occur simultaneously with the event of the film boiling. Thus, at least two types of the first to the fourth UFBs may be generated at the same time, and these generation causes may cooperate to generate the UFBs. It should be noted that it is common for all the generation causes to be induced by the volume change of the film boiling bubble generated by the film boiling phenomenon. In this specification, the method of generating the UFBs by utilizing the film boiling caused by the rapid heating as described above is referred to as a thermal-ultrafine bubble (T-UFB) generating method. Additionally, the UFBs generated by the T-UFB generating method are referred to as T-UFBs, and the liquid containing the T-UFBs generated by the T-UFB generating method is referred to as a T-UFB-containing liquid.

Almost all the air bubbles generated by the T-UFB generating method are 1.0 μm or less, and milli-bubbles and microbubbles are unlikely to be generated. That is, the T-UFB generating method allows dominant and efficient generation of the UFBs. Additionally, the T-UFBs generated by the T-UFB generating method have larger gas-liquid interface energy than that of the UFBs generated by a conventional method, and the T-UFBs do not disappear easily as long as being stored at normal temperature and normal pressure. Moreover, even if new T-UFBs are generated by new film boiling, it is possible to prevent disappearance of the already generated T-UFBs due to the impact from the new generation. That is, it can be said that the number and the concentration of the T-UFBs contained in the T-UFB-containing liquid have the hysteresis properties depending on the number of times the film boiling is made in the T-UFB-containing liquid. In other words, it is possible to adjust the concentration of the T-UFBs contained in the T-UFB-containing liquid by controlling the number of the heating elements provided in the T-UFB generating unit 300 and the number of the voltage pulse application to the heating elements.

Reference to FIG. 1 is made again. Once the T-UFB-containing liquid W with a desired UFB concentration is generated in the T-UFB generating unit 300, the UFB-containing liquid W is supplied to the post-processing unit 400.

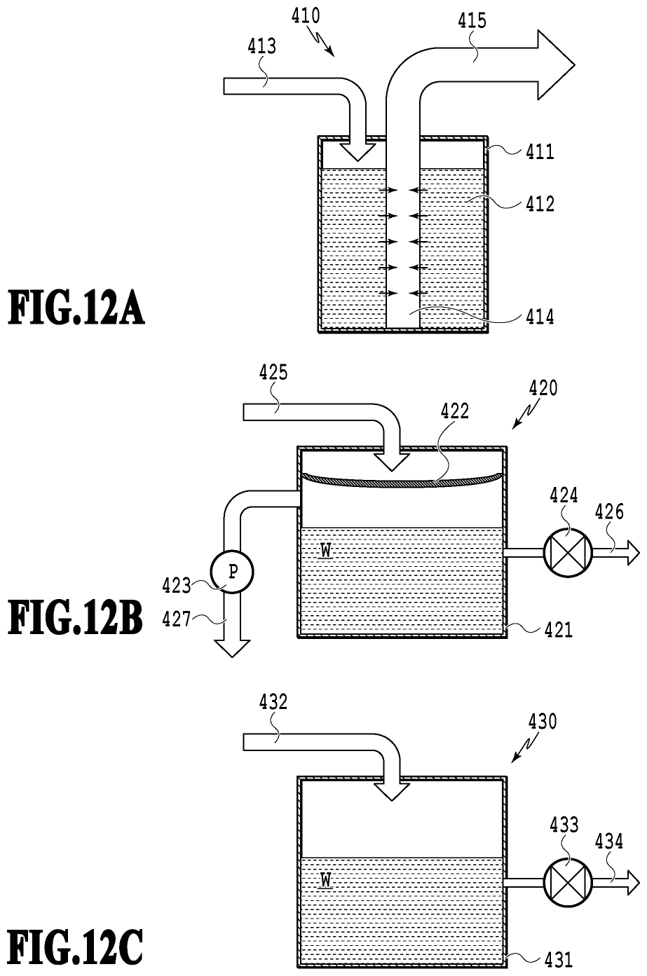

FIGS. 12A to 12C are diagrams illustrating configuration examples of the post-processing unit 400 of this embodiment. The post-processing unit 400 of this embodiment removes impurities in the UFB-containing liquid W in stages in the order from inorganic ions, organic substances, and insoluble solid substances.

FIG. 12A illustrates a first post-processing mechanism 410 that removes the inorganic ions. The first post-processing mechanism 410 includes an exchange container 411, cation exchange resins 412, a liquid introduction passage 413, a collecting pipe 414, and a liquid discharge passage 415. The exchange container 411 stores the cation exchange resins 412. The UFB-containing liquid W generated by the T-UFB generating unit 300 is injected to the exchange container 411 through the liquid introduction passage 413 and absorbed into the cation exchange resins 412 such that the cations as the impurities are removed. Such impurities include metal materials peeled off from the element substrate 12 of the T-UFB generating unit 300, such as SiO₂, SiN, SiC, Ta, Al₂O₃, Ta₂O₅, and Ir.

The cation exchange resins 412 are synthetic resins in which a functional group (ion exchange group) is introduced in a high polymer matrix having a three-dimensional network, and the appearance of the synthetic resins are spherical particles of around 0.4 to 0.7 mm. A general high polymer matrix is the styrene-divinylbenzene copolymer, and the functional group may be that of methacrylic acid series and acrylic acid series, for example. However, the above material is an example. As long as the material can remove desired inorganic ions effectively, the above material can be changed to various materials. The UFB-containing liquid W absorbed in the cation exchange resins 412 to remove the inorganic ions is collected by the collecting pipe 414 and transferred to the next step through the liquid discharge passage 415. In this process in the present embodiment, not all the inorganic ions contained in the UFB-containing liquid W supplied from the liquid introduction passage 413 need to be removed as long as at least a part of the inorganic ions are removed.

FIG. 12B illustrates a second post-processing mechanism 420 that removes the organic substances. The second post-processing mechanism 420 includes a storage container 421, a filtration filter 422, a vacuum pump 423, a valve 424, a liquid introduction passage 425, a liquid discharge passage 426, and an air suction passage 427. Inside of the storage container 421 is divided into upper and lower two regions by the filtration filter 422. The liquid introduction passage 425 is connected to the upper region of the upper and lower two regions, and the air suction passage 427 and the liquid discharge passage 426 are connected to the lower region thereof. Once the vacuum pump 423 is driven with the valve 424 closed, the air in the storage container 421 is discharged through the air suction passage 427 to make the pressure inside the storage container 421 negative pressure, and the UFB-containing liquid W is thereafter introduced from the liquid introduction passage 425. Then, the UFB-containing liquid W from which the impurities are removed by the filtration filter 422 is reserved into the storage container 421.

The impurities removed by the filtration filter 422 include organic materials that may be mixed at a tube or each unit, such as organic compounds including silicon, siloxane, and epoxy, for example. A filter film usable for the filtration filter 422 includes a filter of a sub-μm-mesh (a filter of 1 μm or smaller in mesh diameter) that can remove bacteria, and a filter of a nm-mesh that can remove virus. The filtration filter having such a fine opening diameter may remove air bubbles larger than the opening diameter of the filter. Particularly, there may be the case where the filter is clogged by the fine air bubbles adsorbed to the openings (mesh) of the filter, which may slowdown the filtering speed. However, as described above, most of the air bubbles generated by the T-UFB generating method described in the present embodiment of the invention are in the size of 1 μm or smaller in diameter, and milli-bubbles and microbubbles are not likely to be generated. That is, since the probability of generating milli-bubbles and microbubbles is extremely low, it is possible to suppress the slowdown in the filtering speed due to the adsorption of the air bubbles to the filter. For this reason, it is favorable to apply the filtration filter 422 provided with the filter of 1 μm or smaller in mesh diameter to the system having the T-UFB generating method.

Examples of the filtration applicable to this embodiment may be a so-called dead-end filtration and cross-flow filtration. In the dead-end filtration, the direction of the flow of the supplied liquid and the direction of the flow of the filtration liquid passing through the filter openings are the same, and specifically, the directions of the flows are made along with each other. In contrast, in the cross-flow filtration, the supplied liquid flows in a direction along a filter surface, and specifically, the direction of the flow of the supplied liquid and the direction of the flow of the filtration liquid passing through the filter openings are crossed with each other. It is preferable to apply the cross-flow filtration to suppress the adsorption of the air bubbles to the filter openings. After a certain amount of the UFB-containing liquid W is reserved in the storage container 421, the vacuum pump 423 is stopped and the valve 424 is opened to transfer the T-UFB-containing liquid in the storage container 421 to the next step through the liquid discharge passage 426. Although the vacuum filtration method is employed as the method of removing the organic impurities herein, a gravity filtration method and a pressurized filtration can also be employed as the filtration method using a filter, for example.

FIG. 12C illustrates a third post-processing mechanism 430 that removes the insoluble solid substances. The third post-processing mechanism 430 includes a precipitation container 431, a liquid introduction passage 432, a valve 433, and a liquid discharge passage 434.

First, a predetermined amount of the UFB-containing liquid W is reserved into the precipitation container 431 through the liquid introduction passage 432 with the valve 433 closed, and leaving it for a while. Meanwhile, the solid substances in the UFB-containing liquid W are precipitated onto the bottom of the precipitation container 431 by gravity. Among the bubbles in the UFB-containing liquid, relatively large bubbles such as microbubbles are raised to the liquid surface by the buoyancy and also removed from the UFB-containing liquid. After a lapse of sufficient time, the valve 433 is opened, and the UFB-containing liquid W from which the solid substances and large bubbles are removed is transferred to the collecting unit 500 through the liquid discharge passage 434. The example of applying the three post-processing mechanisms in sequence is shown in this embodiment; however, it is not limited thereto, and the order of the three post-processing mechanisms may be changed, or at least one needed post-processing mechanism may be employed.

Reference to FIG. 1 is made again. The T-UFB-containing liquid W from which the impurities are removed by the post-processing unit 400 may be directly transferred to the collecting unit 500 or may be put back to the dissolving unit 200 again. In the latter case, the gas dissolution concentration of the T-UFB-containing liquid W that is decreased due to the generation of the T-UFBs can be compensated to the saturated state again by the dissolving unit 200. If new T-UFBs are generated by the T-UFB generating unit 300 after the compensation, it is possible to further increase the concentration of the UFBs contained in the T-UFB-containing liquid with the above-described properties. That is, it is possible to increase the concentration of the contained UFBs by the number of circulations through the dissolving unit 200, the T-UFB generating unit 300, and the post-processing unit 400, and it is possible to transfer the UFB-containing liquid W to the collecting unit 500 after a predetermined concentration of the contained UFBs is obtained. This embodiment shows a form in which the UFB-containing liquid processed by the post-processing unit 400 is put back to the dissolving unit 200 and circulated; however, it is not limited thereto, and the UFB-containing liquid after passing through the T-UFB generating unit may be put back again to the dissolving unit 200 before being supplied to the post-processing unit 400 such that the post-processing is performed by the post-processing unit 400 after the T-UFB concentration is increased through multiple times of circulation, for example.

The collecting unit 500 collects and preserves the UFB-containing liquid W transferred from the post-processing unit 400. The T-UFB-containing liquid collected by the collecting unit 500 is a UFB-containing liquid with high purity from which various impurities are removed.

In the collecting unit 500, the UFB-containing liquid W may be classified by the size of the T-UFBs by performing some stages of filtration processing. Since it is expected that the temperature of the T-UFB-containing liquid W obtained by the T-UFB method is higher than normal temperature, the collecting unit 500 may be provided with a cooling unit. The cooling unit may be provided to a part of the post-processing unit 400.

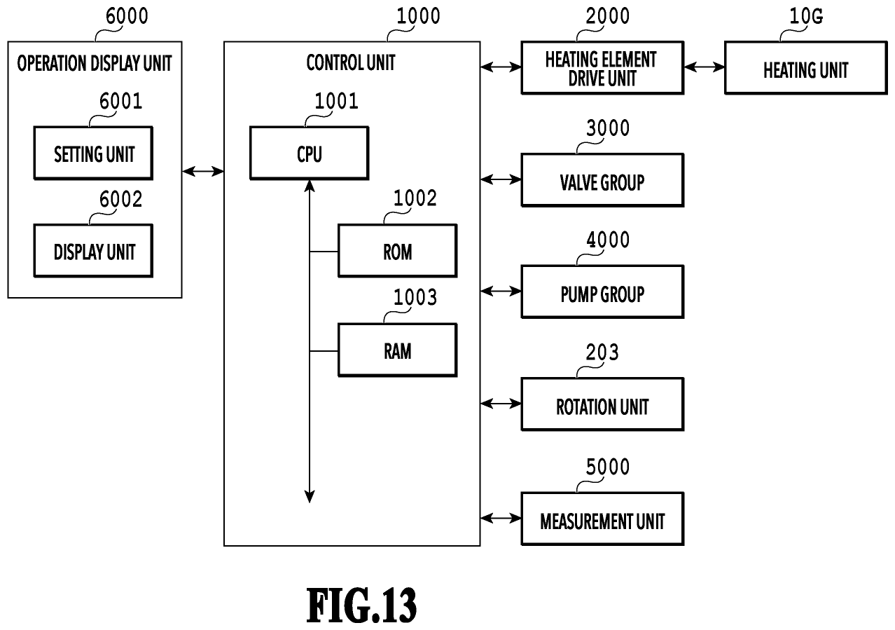

FIG. 13 is a block diagram illustrating a schematic configuration of a control system provided in the embodiment. In FIG. 13, a control unit 1000 includes, for example, a CPU 1001, a ROM 1002, a RAM 1003, and the like. The CPU 1001 functions as control means that integrally controls an entire UFB-containing liquid production apparatus 1A. The ROM 1002 stores control programs executed by the CPU 1001, predetermined tables, and other pieces of fixed data. The RAM 1003 includes a region in which various pieces of input data are temporarily stored, a work area used in execution of processing by the CPU 1001, and the like. An operation display unit 6000 includes a setting unit 6001 in which a user performs various setting operations including setting of a UFB concentration in the UFB-containing liquid, UFB production time, and the like and a display unit (display means) 6002 that displays time required for production of the UFB-containing liquid, the status of the apparatus, and the like.

A heating element drive unit (driving unit) 2000 that controls drive of each of multiple heating elements 10 (see FIG. 5A) provided on the element substrate 12 and included in a heating unit 10G is connected to the control unit 1000. The heating element drive unit 2000 applies a drive pulse corresponding to a control signal from the CPU 1001 to each of the multiple heating elements 10 included in the heating unit 10G. Each heating element 10 generates heat depending on the voltage, frequency, pulse width, and the like of the applied drive pulse.

The control unit 1000 controls a valve group 3000 including opening-closing valves provided in the respective units and the like. Moreover, the control unit 1000 controls a not-illustrated motor, a pump group 4000 including various types of pumps provided in the UFB-containing liquid production apparatus 1A, and the like. Furthermore, the UFB-containing liquid production apparatus 1A is provided with a measurement unit 5000 that performs various types of measurement. The measurement unit 5000 includes, for example, a measurement device that measures the UFB concentration and flow rate of the produced UFB -containing liquid, a measurement unit that measures an accumulation amount of the UFB-containing liquid in a buffer tank 1030, and the like. Measurement values outputted from the measurement unit 5000 are inputted into the control unit 1000.

The schematic description of the UFB generating apparatus 1 is given above; however, it is needless to say that the illustrated multiple units can be changed, and not all of them need to be prepared. Depending on the type of the liquid W and the gas G to be used and the intended use of the T-UFB-containing liquid to be generated, a part of the above-described units may be omitted, or another unit other than the above-described units may be added.

For example, when the gas to be contained by the UFBs is the atmospheric air, the degassing unit as the pre-processing unit 100 and the dissolving unit 200 can be omitted. On the other hand, when multiple kinds of gases are desired to be contained by the UFBs, another dissolving unit 200 may be added.

The units for removing the impurities as described in FIGS. 12A to 12C may be provided upstream of the T-UFB generating unit 300 or may be provided both upstream and downstream thereof. When the liquid to be supplied to the UFB generating apparatus is tap water, rain water, contaminated water, or the like, there may be included organic and inorganic impurities in the liquid. If such a liquid W including the impurities is supplied to the T-UFB generating unit 300, there is a risk of deteriorating the heating element 10 and inducing the salting-out phenomenon. With the mechanisms as illustrated in FIGS. 12A to 12C provided upstream of the T-UFB generating unit 300, it is possible to remove the above-described impurities previously.

### First Embodiment

Next, a first embodiment of the present invention is described. A UFB-containing liquid production apparatus in the embodiment generates UFBs in a supplied gas-dissolved liquid, with a UFB generation unit employing the T-UFB method using a heater, as in the aforementioned basic configuration. As described above, in the T-UFB method, no bubbles (micro-bubbles (hereinafter, referred to as MBs) and millimeter bubbles) having larger diameters than the UFBs are generated and only the UFBs are generated. Accordingly, it can be said that the T-UFB method is a very effective UFB generation method in producing a high-concentration UFB -containing liquid. However, a conventional UFB-containing liquid production apparatus using the UFB generation unit employing the T-UFB generation method has the following problem: in the case where the MBs are contained in a liquid supplied to a portion near the UFB generation unit, the generation of the UFBs is hindered by the MBs and generation efficiency of the UFBs decreases in some cases. This embodiment can eliminate the problem of the conventional apparatus in which the generation efficiency of the UFBs decreases due to the effect of the MBs. First, an outline of the conventional apparatus is described below to clarify the effectiveness of the embodiment and then the configurations and operations of the embodiment are described.

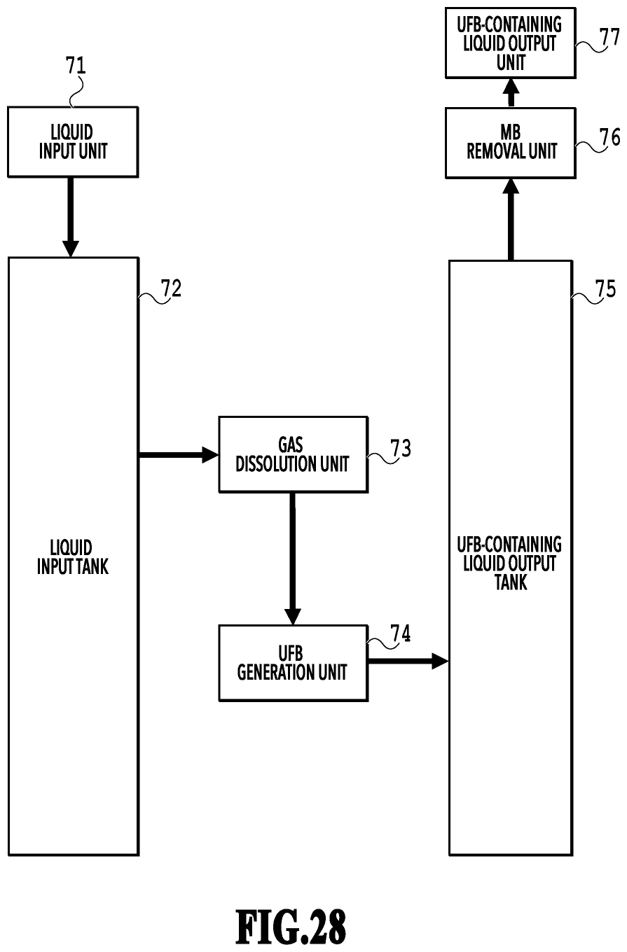

FIG. 28 is a diagram illustrating a schematic configuration of the conventional UFB-containing liquid production apparatus. In the UFB-containing liquid production apparatus, a liquid (for example, water) to be the target of UFB generation is supplied from a liquid input unit 71 to a liquid input tank 72 and is then supplied to a gas dissolution unit 73. The gas dissolution unit 73 produces the gas-dissolved liquid by dissolving the gas into the supplied liquid and supplies the gas-dissolved liquid to a UFB generation unit 74. The UFB generation unit 74 generates the UFBs in the gas-dissolved liquid supplied from the gas dissolution unit 73 and produces the UFB-containing liquid. The UFB-containing liquid generated in the UFB generation unit 74 is sent to a UFB-containing liquid output tank 75, then sent to a UFB-containing liquid output unit 77 via a MB removal unit 76, and supplied to a predetermined UFB -containing liquid using apparatus.

As described above, the conventional UFB-containing liquid production apparatus employs a configuration in which purity of the UFB-containing liquid is increased by removing the MBs in the MB removal unit 76 arranged downstream of the UFB generation unit 74 (just behind the UFB-containing liquid output unit 77). However, in the conventional UFB-containing liquid production apparatus, the MBs present in the liquid supplied from the liquid input unit 71 and the MBs generated between the liquid input unit 71 and the gas dissolution unit 73 are supplied to the UFB generation unit 74 as they are. Accordingly, in the conventional UFB-containing liquid production apparatus, the UFBs are generated with the MBs present in the UFB generation unit 74 and this causes the generation efficiency of the UFBs to decrease.

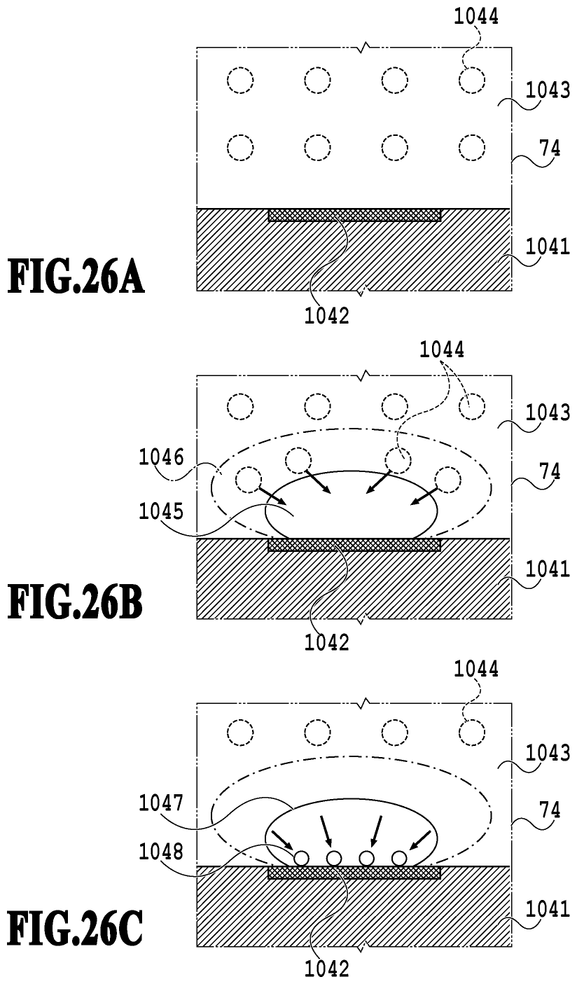

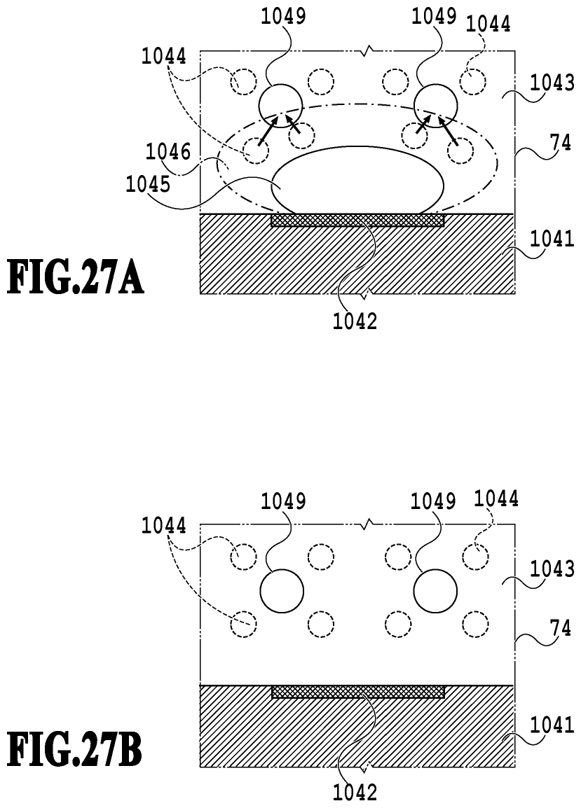

Production of the UFB-containing liquid and effects of MBs contained in the UFB-containing liquid on the generation of UFBs are described with reference to FIGS. 26A to 27B. FIGS. 26A to 26C are views illustrating a UFB generation process in the case where there are no MBs in the UFB-containing liquid supplied to the UFB generation unit 74. The UFB generation unit 74 illustrated in FIGS. 26A to 26C includes a substrate 1041 provided with a heater 1042 and generates the UFBs in the T-UFB method. Reference numeral 1044 in FIGS. 26A to 26C denotes a dissolved gas contained in a gas-dissolved liquid 1043.

FIG. 26B illustrates a state where the heater 1042 generates a film-boiling bubble in the gas-dissolved liquid 1043. Reference numeral 1046 in FIG. 26B denotes a region (temperature rise region) in which temperature rises due to a heating operation of the heater 1042. The saturation solubility of the dissolved gas 1044 in the temperature rise region 1046 decreases with the temperature rise and, in the case where the dissolved gas concentration exceeds the saturation solubility, the gas goes into a state where it tends to separate (supersaturated state). The dissolved gas in the supersaturated state separates by coming into contact with gas or receiving an impact. In the example, the dissolved gas 1044 in the temperature rise region 1046 separates by coming into contact with the film-boiling bubble 1045 formed by the heating of the heater 1042 as illustrated in FIG. 26B.

Then, as illustrated in FIG. 26C, the film-boiling bubble 1045 disappears over time and the separated gas turns into UFBs 1048. The UFBs 1048 are drawn toward the heater 1042 as illustrated by the arrows in FIG. 26C with the disappearance of the film-boiling bubble 1045. A region 1047 in FIG. 26C illustrates a region in which the film-boiling bubble 1045 has been present, and is filled with the liquid 1043 at the point of disappearance of the film-boiling bubble 1045. Bubbles that are not dissolved into the liquid 1043 again among the bubbles of gas separated due to contact with the film-boiling bubble 1045 as described above remain in the liquid 1043 as the UFBs 1048.

Meanwhile, FIGS. 27A and 27B are views illustrating a UFB generation process performed in a state where MBs 1049 are present in the UFB-containing liquid supplied to the UFB generation unit 74. The FIG. 27A illustrates a state where the film-boiling bubble 1045 is formed. In the case where the MBs 1049 are present in the UFB-containing liquid 1043, the dissolved gas 1044 in the temperature rise region 1046 partially comes into contact with the MBs 1049 and separates before coming into contact with the film-boiling bubble 1045. However, since this separated gas is taken into the MBs 1049 and is used to increase the sizes of the MBs 1049, the separated gas does not contribute to the generation of UFBs. The presence of the MBs 1049 and bubbles with greater sizes than the MBs 1049 thus causes a decrease in the generation efficiency of the UFBs.

Note that a similar phenomenon occurs also in the case of using a UFB generation method in which the dissolved gas is separated by reducing the pressure of the liquid by using the Venturi method or the like. Specifically, in the case where the MBs 1049 or bubbles with greater sizes than the MBs 1049 are present in the gas-dissolved liquid 1043 supplied to the UFB generation unit 74, the dissolved gas 1044 is used for growth of the present bubbles and the generation efficiency of the UFBs decreases.

In order to solve the aforementioned problems of the conventional apparatus, the UFB-containing liquid production apparatus 1A in the embodiment has the following configuration.

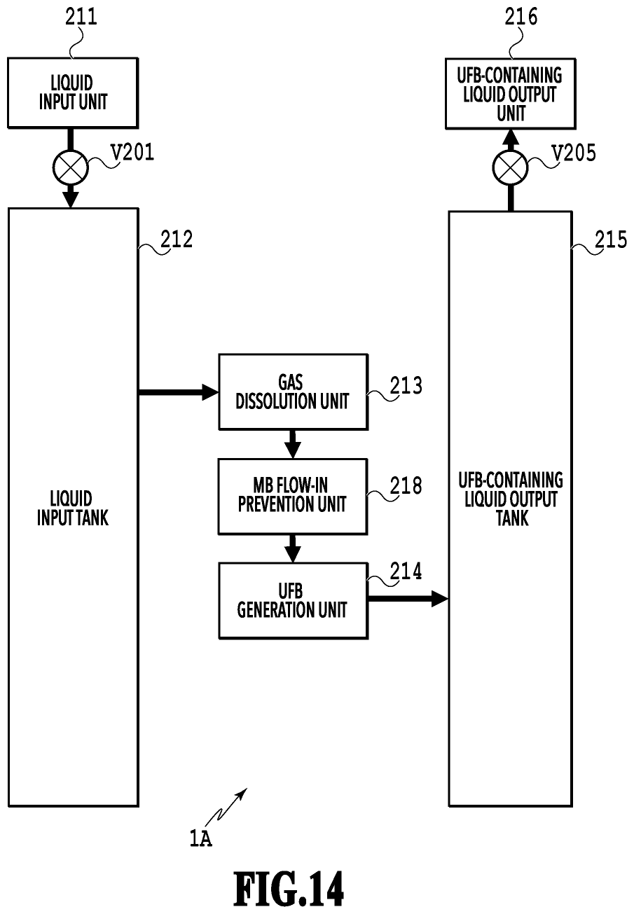

FIG. 14 is a block diagram schematically illustrating the configuration in the embodiment. The UFB-containing liquid production apparatus 1A illustrated in FIG. 14 includes a liquid input unit 211, a liquid input tank 212, a gas dissolution unit 213, an MB flow-in prevention unit 218, a UFB generation unit 214, a UFB-containing liquid output tank 215, and a UFB-containing liquid output unit 216. Moreover, a valve V201 is provided between the liquid input unit 211 and the liquid input tank (liquid supply unit) 212 and a valve V205 is provided between the UFB-containing liquid output tank 215 and the UFB-containing liquid output unit 216. A control unit to be described later controls opening and closing of the valves V201 and V205.

Functions of the aforementioned units are described. The liquid input unit 211 supplies a liquid (for example, water) being the target of UFB generation to the liquid input tank 212 via the valve V201. The liquid input tank 212 receives the liquid supplied from the liquid input unit 211 once and then supplies the liquid to the gas dissolution unit 213. The gas dissolution unit 213 performs a role of producing a gas-dissolved liquid by dissolving a gas into the liquid supplied from the liquid input tank 212 being the liquid supply unit and a role of supplying the produced gas-dissolved liquid to the MB flow-in prevention unit 218. Note that a method such as a pressurized dissolution method or bubbling is used as the method of dissolving the gas into the liquid.

The MB flow-in prevention unit 218 performs a role of a micro-bubble reduction unit that removes or isolates the MBs contained in the gas-dissolved liquid supplied from the gas dissolution unit 213 and supplies the gas-dissolved liquid in which the MBs are reduced (MB reduced liquid) to the UFB generation unit 214 provided downstream of the MB flow-in prevention unit 218. The MB flow-in prevention unit 218 can employ a method in which the MBs are prevented from flowing downstream by using a physical filter, a method in which the gas-dissolved liquid supplied from the gas dissolution unit 213 is stored for a certain period to cause the MBs to float to the liquid surface by utilizing buoyancy of the MBs and disappear, or a similar method. For example, a sheet-shaped member in which filter holes that do not allow the MBs to pass and that allow the UFBs to pass are formed may be used as the filter.

The UFB generation unit 214 generates the UFBs in the gas-dissolved liquid which is supplied from the gas dissolution unit 213 and in which the MBs are reduced (MB reduced liquid) and produces the UFB-containing liquid. In the embodiment, the UFBs are generated in the supplied gas-dissolved liquid by employing the T-UFB method using a heater as in the aforementioned basic configuration. The UFB-containing liquid generated in the UFB generation unit 214 is sent to the UFB-containing liquid output tank 215.

The UFB-containing liquid output tank 215 performs a role as a liquid collection unit that collects the UFB-containing liquid supplied from the UFB generation unit 214 once, and supplies the collected liquid to the UFB-containing liquid output unit 216 via the valve V205. The UFB-containing liquid output unit 216 performs a role as a liquid output unit that supplies the UFB-containing liquid to a predetermined UFB-containing liquid using apparatus.

In the embodiment, the UFBs are generated in the supplied gas-dissolved liquid by employing the T-UFB method using a heater as in the aforementioned basic configuration. The UFB-containing liquid containing the UFBs are transferred to the UFB-containing liquid output tank 215.

Note that, in the aforementioned configuration, the configurations of the units described in the aforementioned basic configuration can be applied to the units other than the MB flow-in prevention unit 218. In other words, the configuration of the pretreatment apparatus 100 described in the basic configuration can be applied to the liquid input tank 212. The configuration of the dissolution unit 200 described in the basic configuration can be applied to the gas dissolution unit 213. The configuration of the T-UFB generation unit 300 described in the basic configuration can be applied to the UFB generation unit 214. The configuration of the post-treatment unit 400 described in the basic configuration can be applied to the UFB-containing liquid output tank 215. Moreover, the collection unit 500 described in the basic configuration can be applied to the UFB-containing liquid output unit 216.

As described above, in the embodiment, the MB flow-in prevention unit 218 is arranged upstream of the UFB generation unit 214. Accordingly, the MB flow-in prevention unit 218 removes or reduces the MBs present in the liquid supplied from the liquid input unit 211 in advance and the MBs generated between the liquid input unit 211 and the gas dissolution unit 213 before the MBs flow into the UFB generation unit 214. Thus, the UFB generation unit 214 performs the generation of the UFBs on the MB reduced liquid and can efficiently generate the UFB-containing liquid with a desired UFB concentration and high purity. Specifically, in the embodiment, as described above in FIGS. 26A to 26C, the dissolved gas 1044 separates by coming into contact with the film-boiling bubble 1045, the separated bubbles remain in the liquid as the UFBs, and the UFB-containing liquid with high concentration and high purity is generated. In other words, in the embodiment, occurrence of the phenomenon in which the dissolved gas 1044 in the gas-dissolved liquid 1043 separates by coming into contact with the MBs before coming into contact with the film-boiling bubble 1045 and is taken into the MBs 1049 as illustrated in FIGS. 27A and 27B is greatly reduced. As a result, the UFB generation efficiency is greatly improved from that of the conventional apparatus. This is an extremely large improvement effect for a UFB-containing liquid using apparatus that requires high-concentration UFBs as in a medical apparatus and the like.

### Modified Example of First Embodiment

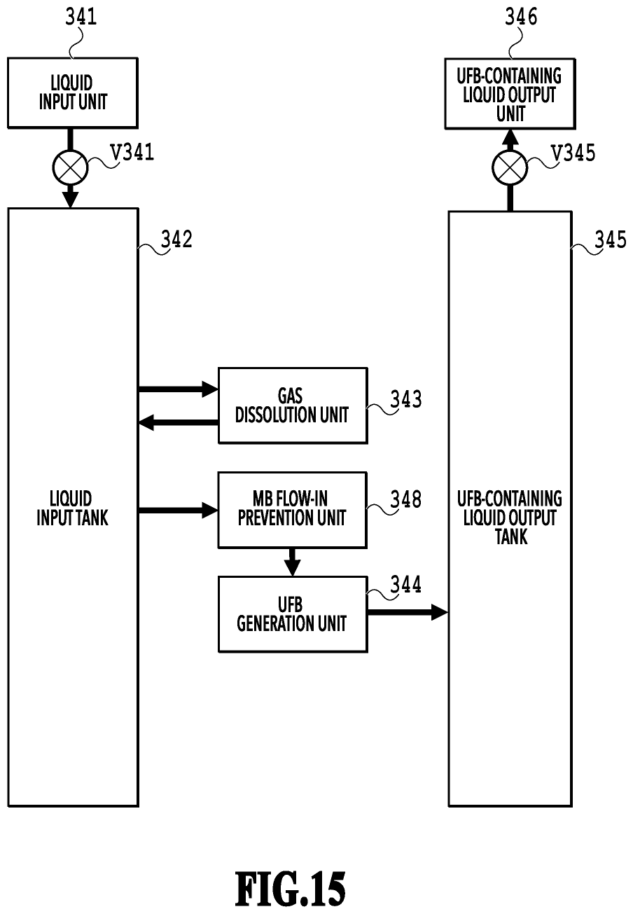

FIG. 15 illustrates a modified example of the first embodiment. The modified example is an example in which an independently-controllable gas dissolution unit 343 is provided instead of the gas dissolution unit 213 of the UFB-containing liquid production apparatus illustrated in FIG. 14.

Since a liquid input unit 341, a UFB generation unit 344, a UFB-containing liquid output tank 345, a UFB-containing liquid output unit 346, and valves V341 and V345 illustrated in FIG. 15 are the same as 201, 204, 205, 206, V201, and V205 illustrated in FIG. 14, description thereof is omitted.

A liquid input tank 342 receives supply from the liquid input unit 341 and supplies the received liquid to a gas dissolution unit 343. The liquid input tank 342 also receives supply of a liquid into which a gas is already dissolved, from the gas dissolution unit 343 and supplies the received liquid to an MB flow-in prevention unit 348. The gas dissolution unit 343 receives the liquid supplied from the liquid input tank 342, produces the gas-dissolved liquid by dissolving the gas into the received liquid, and then supplies the produced gas-dissolved liquid to the liquid input tank 342. A method such as pressurized dissolution method or bubbling is used as a gas dissolving method in the gas dissolution unit 343.

The liquid input tank 342 supplies the gas-dissolved liquid supplied from the gas dissolution unit 343 to the MB flow-in prevention unit 348. The MB flow-in prevention unit 348 having received the supply of the gas-dissolved liquid from the liquid input tank 342 performs a role of producing the MB reduced liquid by removing or isolating the MBs from the gas-dissolved liquid and supplying the MB reduced liquid to a UFB generation heater.

As described above, in the modified example, the apparatus is configured such that the gas dissolution unit 343 is not directly connected to the MB flow-in prevention unit 348 and the gas-dissolved liquid generated in the gas dissolution unit 343 is returned to the liquid input tank 342 and then supplied from the liquid input tank 342 to the MB flow-in prevention unit 348. Employing the configuration in which the liquid is exchanged between the liquid input tank 342 and the gas dissolution unit 343 as described above can suppress a decrease in UFB generation efficiency and allows independent control of the degree of gas dissolution in the gas dissolution unit 343.

In the case where the configuration in which the gas dissolution unit 343 is independently controlled is employed, the gas dissolution unit 343 can be formed of multiple gas dissolution mechanisms. In this case, it is possible to dissolve various types of gases such as, for example, oxygen, nitrogen, hydrogen, and ozone into the liquid in the respective gas dissolution mechanisms and the gases to be dissolved into the liquid can be selected with a greater degree of freedom.

Moreover, multiple gas dissolution units 343 may include multiple dissolution units to allow an increase in a control range of a generation rate of the dissolved gas. In this case, the gas-dissolved liquid with a desired gas dissolution amount can be produced at a rate depending on a necessary generation rate of the UFB-containing liquid. Accordingly, even if the production rate of the gas-dissolved liquid in one dissolution unit is lower than the necessary UFB generation rate, it is possible to cause multiple dissolution units to operate and increase the UFB generation rate as a whole. This can avoid the case where the production rate of the gas-dissolved liquid in the gas dissolution unit 343 becomes a bottleneck of the generation rate of the UFB-containing liquid.

As described above, in the modified example, it is possible to supply the gas-dissolved liquid with the desired gas dissolution amount to the UFB generation unit 344 by independently controlling the degree of gas dissolution in the gas-dissolved liquid in the gas dissolution unit 343 and generate the high-concentration UFB-containing liquid more efficiently. Generally, in the case where the gas dissolution unit increases the gas dissolution amount in the gas-dissolved liquid, the MB content in the gas-dissolved liquid increases. Accordingly, in the case where the gas-dissolved liquid with a large MB content is supplied to the UFB generation unit 344 as it is, the UFBs generated in the UFB generation unit 344 are taken into the MBs and the UFB generation efficiency decreases. As a result, even if the gas dissolution amount is increased in the gas dissolution unit, a sufficient UFB concentration cannot be obtained and the UFB generation efficiency is low. Meanwhile, in this modified example, the MB flow-in prevention unit 348 reduces the MB content even if the MB content increases with an increase of the gas dissolution amount. Accordingly, the gas-dissolved liquid with high gas dissolution amount and few MBs can be supplied to the UFB generation unit 344. Thus, the gas dissolution amount can be freely controlled in the gas dissolution unit 343. Hence, the UFBs can be efficiently generated at high concentration and high purity by supplying the gas-dissolved liquid whose gas dissolution amount is increased in the gas dissolution unit 343 to the UFB generation unit 344.

As described above, in the modified example, a synergetic effect of improving the production efficiency of the high-concentration, high-purity UFB-containing liquid and securing a production amount of the UFB-containing liquid can be obtained by providing the independently-controllable gas dissolution unit 343 and the MB flow-in prevention unit 348. Moreover, in the case where the apparatus employs the configuration including multiple gas dissolution units 343, the apparatus needs to include only one MB flow-in prevention unit 348 and the cost and size of the apparatus can be reduced.

### Second Embodiment

Next, a second embodiment of the present invention is described. In the first embodiment, description is given of the example in which the UFB generation efficiency is improved by providing the MB flow-in prevention unit behind the UFB generation heater. Meanwhile, in this embodiment, description is given of an example in which a circulating pump 409 is used to enable production of a UFB-containing liquid with a higher concentration.

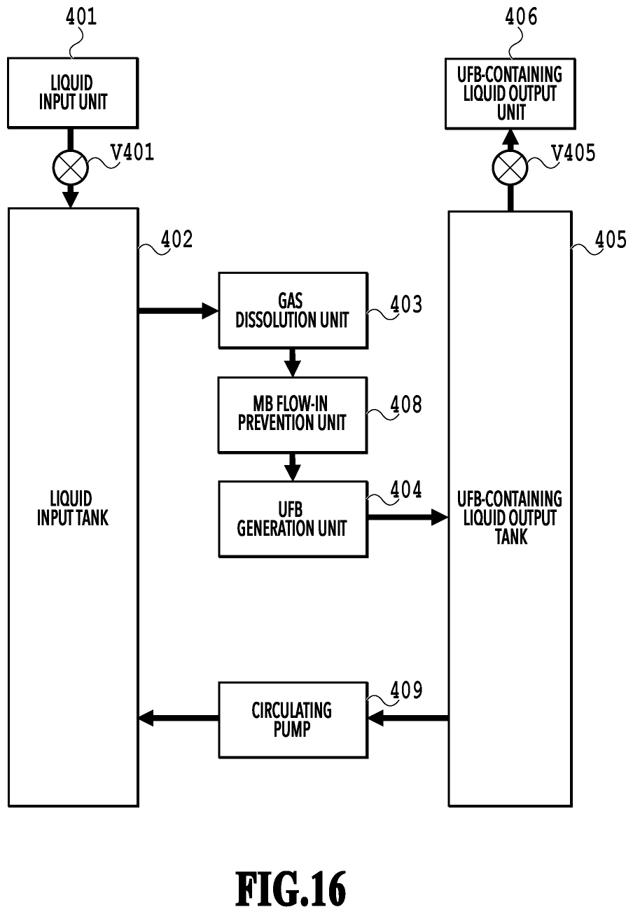

FIG. 16 illustrates an apparatus configuration in the embodiment. A liquid input unit 401, a liquid input tank 402, a gas dissolution unit 403, an MB flow-in prevention unit 408, a UFB generation unit 404, a UFB-containing liquid output tank 405, a UFB-containing liquid output unit 406, and valves V401 and V405 illustrated in FIG. 16 are the same as 201 to 208, V201, and V205 illustrated in FIG. 14. Accordingly, detailed description thereof is omitted.

The circulating pump 409 is connected to the UFB-containing liquid output tank 405 and the liquid input tank 402 and has a role of receiving supply of the UFB -containing liquid from the UFB-containing liquid output tank 405 and supplying the UFB-containing liquid to the liquid input tank 402. A tube pump, a gear pump, a diaphragm pump, or the like can be used as the circulating pump 409.

A circulation path is formed in which the circulating pump 409 causes the liquid supplied to the liquid input tank 402 to flow from the liquid input tank 402 to the gas dissolution unit 403, to the MB flow-in prevention unit 408, to the UFB generation unit 404, and to the UFB-containing liquid output tank 405 and return to the liquid input tank 402 via the circulating pump 409.

Forming the circulation path as described above allows the dissolution of gas, the reduction of MBs, and the generation of UFBs to be repeatedly performed on the UFB-containing liquid generated in the UFB generation unit 404 and the UFB concentration can be increased.

Closing the valves V401 and V405 while the circulating pump 409 is operating forms a complete circulation path from which no liquid flows out and the liquid circulates in this circulation path. Circulating the liquid in the complete circulation path can improve the concentration of generated UFBs most efficiently. Moreover, it is possible to increase the UFB concentration while stably supplying a certain amount of the UFB-containing liquid by not completely closing the valves V401 and V405 such that the average flow rate of the circulating pump 409 is higher than the average flow rate of the valves V401 and V405.

According to the embodiment, it is possible to obtain a synergetic effect of increasing the UFB concentration by circulating the liquid in the circulation path and improving the UFB generation efficiency by reducing the MB amount with the MB flow-in prevention unit 408.

### First Modified Example of Second Embodiment

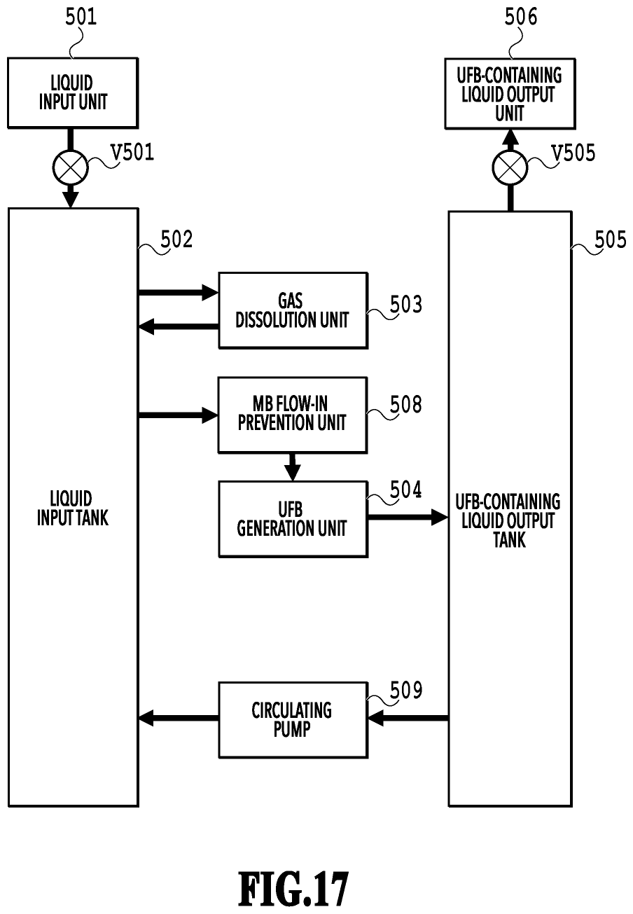

FIG. 17 illustrates a first modified example of the second embodiment. This modified example is an example in which an independently-controllable gas dissolution unit 503 is provided instead of the gas dissolution unit 403 in the UFB-containing liquid production apparatus illustrated in FIG. 16. Specifically, in the modified example, the apparatus has a configuration including an MB flow-in prevention unit 508 on the liquid flow-in side of the UFB generation unit 504 in the circulation path of the liquid and also including the independently-controllable gas dissolution unit 503. Note that a liquid input unit 501, the UFB generation unit 504 to a UFB-containing liquid output unit 506, valves V501 and V505, and a circulating pump 509 illustrated in FIG. 17 are the same as 401, 404 to 406, V401, V405, and 409 illustrated in FIG. 16.

According to the configuration described in the modified example, it is possible to achieve both of:
the degree of freedom of the gas dissolution unit 503 described in the first modified example of the first embodiment; and
the production of high-concentration UFB-containing liquid achieved by the circulation described in the second embodiment,

while obtaining a syngeneic effect with an improvement in the UFB generation efficiency achieved by reducing the MB amount with the MB flow-in prevention unit 508.

### Second Modified Example of Second Embodiment

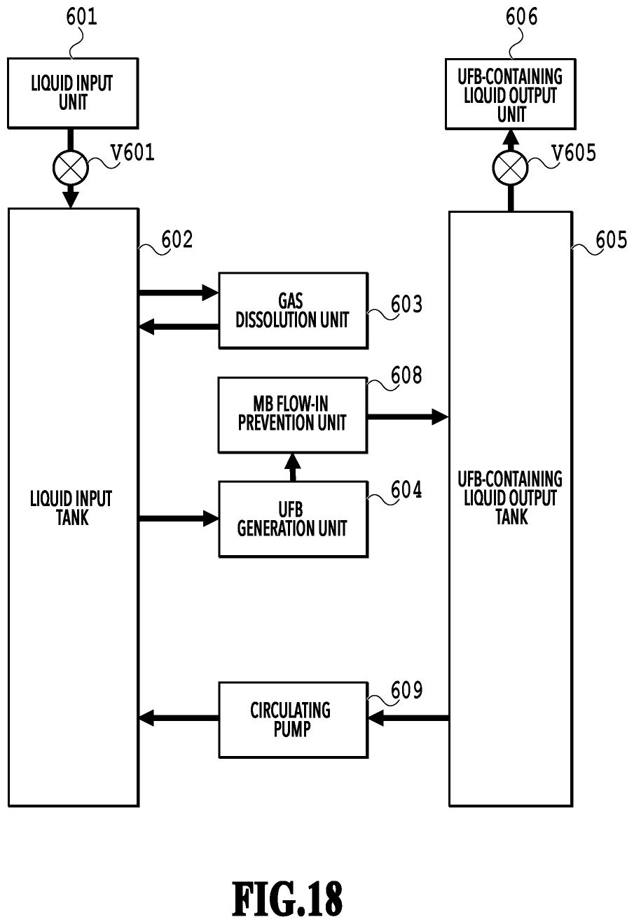

FIG. 18 illustrates a second modified example of the second embodiment. In the modified example, the apparatus has a configuration in which an MB flow-in prevention unit 608 is provided on the liquid flow-out side of a UFB generation unit provided in a liquid circulation path. More specifically, the apparatus has the following liquid flow passage configuration. A liquid input tank 602 supplies the liquid supplied from a liquid input unit 601 to a gas dissolution unit 603 and receives the gas-dissolved liquid from the gas dissolution unit 603. The liquid input tank 602 supplies the gas-dissolved liquid supplied from the gas dissolution unit to a UFB generation unit 604. The UFB generation unit 604 generates the UFBs in the gas-dissolved liquid supplied from the liquid input tank 602 and supplies the generated UFB-containing liquid to the MB flow-in prevention unit 608.

The MB flow-in prevention unit 608 receives the supply of the UFB-containing liquid from the UFB generation unit 604, produces the MB reduced liquid by removing or isolating the MBs, and supplies the MB reduced liquid to a UFB-containing liquid output tank 605. The UFB-containing liquid output tank 605 performs a role of receiving the supply of the UFB-containing liquid from the MB flow-in prevention unit 608 and supplying the UFB-containing liquid to a UFB-containing liquid output unit 606 and a circulating pump 609. The circulating pump 609 returns the liquid supplied from the UFB-containing liquid output tank 605 to the liquid input tank 602. Closing valves V601 and V605 after a sufficient amount of the liquid is supplied to the liquid input tank 602 causes the liquid received in the UFB-containing liquid output tank 605 to be supplied only to the circulating pump 609 and the liquid circulation path is thus formed.

As described above, in the modified example, the UFB-containing liquid generated in the UFB generation unit 604 is subjected to the removable or reduction of MBs by the MB flow-in prevention unit 608 before flowing into the UFB-containing liquid output tank 605. This allows the MB amount in the UFB-containing liquid circulating in the circulation path to be reduced before the UFB-containing liquid reaches the UFB generation unit 604 again and the decrease in the UFB generation efficiency due to the MBs can be suppressed. The configuration in which the MB flow-in prevention unit 608 is arranged on the liquid flow-out side of the UFB generation unit 604 as described above is particularly effective in the case where the UFB generation unit 604 is an unit employing the Venturi method. Generally, in the case where the UFB generation unit 604 employs the Venturi method, the MBs are generated together with the UFBs in the production of the UFB-containing liquid. Accordingly, the MB reduced liquid can be supplied to the UFB generation unit 604 by providing the MB flow-in prevention unit 608 on the liquid flow-out side of the UFB generation unit 604 in the circulation path and removing the MBs from the UFB-containing liquid before the UFB-containing liquid flows into the UFB-containing liquid output tank 605. Thus, excellent UFB generation efficiency can be obtained also in the UFB generation unit 604 employing the Venturi method. Note that the modified example is effective also in the case of using the UFB generation unit 604 employing the T-UFB method in which no MBs are generated in the UFB generation.

### Third Modified Example of Second Embodiment

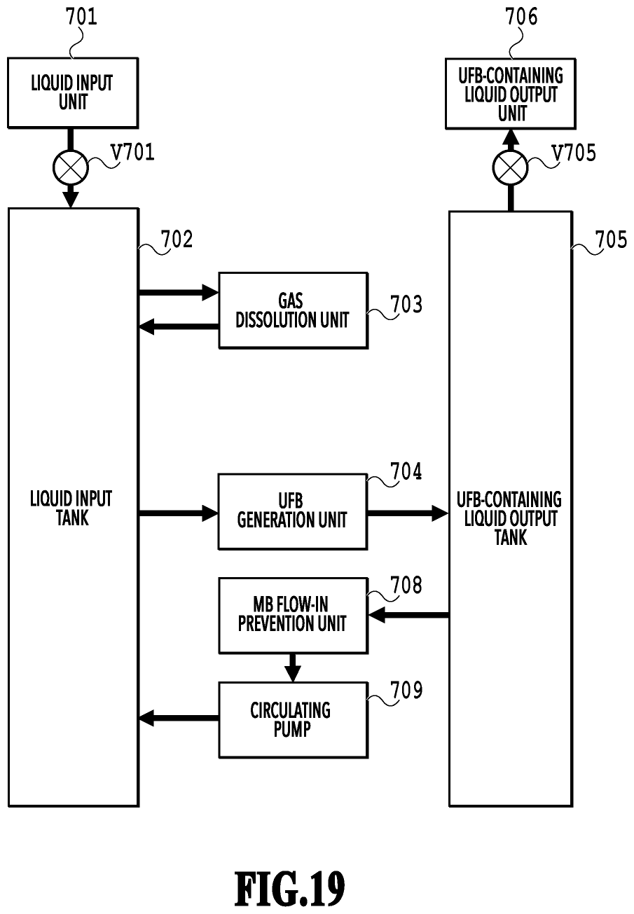

FIG. 19 illustrates a third modified example of a second embodiment. In the modified example, the apparatus has a configuration in which an MB flow-in prevention unit 708 is provided on the liquid flow-in side of a circulating pump 709. Specifically, the apparatus has the following configuration. A liquid input tank 702 exchanges the liquid with a gas dissolution unit 703 and supplies the gas-dissolved liquid supplied from the gas dissolution unit 703 to a UFB generation unit 704 as in the second modified example. The UFB generation unit 704 generates the UFBs in the gas-dissolved liquid supplied from the liquid input tank 702 and supplies the generated UFB-containing liquid to a UFB-containing liquid output tank 705. The UFB-containing liquid output tank 705 receives the UFB-containing liquid supplied from the UFB generation unit 704 and supplies the UFB-containing liquid to the UFB-containing liquid output unit 706 and the MB flow-in prevention unit 708.

The MB flow-in prevention unit 708 receives supply of the UFB-containing liquid from the UFB-containing liquid output tank 705, produces the MB reduced liquid by removing or isolating the MBs, and supplies the generated MB reduced liquid to the circulating pump 709. The circulating pump 709 returns the UFB-containing liquid supplied from the MB flow-in prevention unit 708 to the liquid input tank 702. Note that the circulation path of this liquid is formed by closing valves V701 and V705.

In the case where the liquid containing the MBs flows into the circulating pump 709, the pressure and flow rate in the circulating pump 709 increase and the MBs may take in the dissolved gas and the generated UFBs and expand. However, the configuration described in the modified example can remove and reduce the MBs before the MBs accumulated in the UFB-containing liquid output tank enter the circulating pump. Accordingly, it is possible to reduce the MB amount in the circulated UFB-containing liquid in the case where the liquid reaches the UFB generation unit 704 again and obtain excellent UFB generation efficiency in the UFB generation unit 704.

### Fourth Modified Example of Second Embodiment

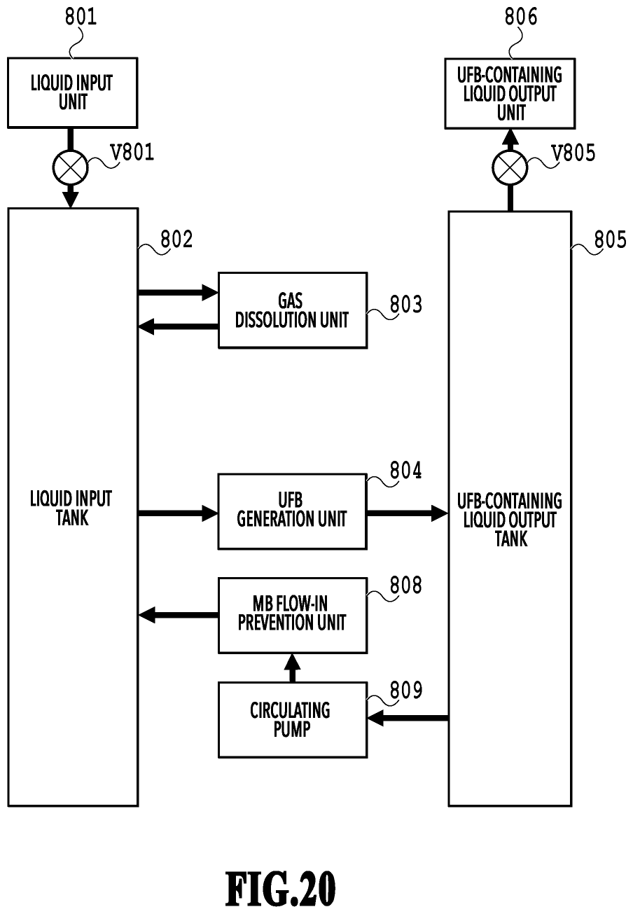

FIG. 20 illustrates a fourth modified example of the second embodiment. In this modified example, the apparatus has a configuration in which an MB flow-in prevention unit 808 is arranged on the liquid flow-out side of a circulating pump 809. More specifically, the apparatus has the following liquid flow passage configuration. A liquid input tank 802 exchanges the liquid with a gas dissolution unit 803 and supplies the gas-dissolved liquid supplied from the gas dissolution unit 803 to a UFB generation unit 804. The UFB generation unit 804 generates the UFBs in the supplied gas-dissolved liquid and then supplies the UFB-containing liquid to a UFB-containing liquid output tank 805. The UFB-containing liquid output tank 805 receives the UFB-containing liquid supplied from the UFB generation unit 804 and supplies the UFB-containing liquid to a UFB-containing liquid output unit 807 and the circulating pump 809.

The circulating pump 809 supplies the UFB-containing liquid supplied from the UFB-containing liquid output tank 805 to the MB flow-in prevention unit 808. The MB flow-in prevention unit 808 produces the MB reduction liquid by removing or isolating the MBs from the supplied UFB-containing liquid and returns the generated MB reduction liquid to the liquid input tank 802. Note that this liquid circulation path is formed by closing valves V801 and V805.

As described in the aforementioned third modified example, in the circulating pump 809, the pressure and flow rate of the liquid flowing therein increases and there occurs a phenomenon in which the MBs take in the dissolved gas and the generated UFBs and expand. However, in the modified example, the MB flow-in prevention unit 808 having received the UFB-containing liquid supplied from the circulating pump 809 produces the MB reduced liquid by removing or isolating the MBs and supplies the MB reduced liquid to the liquid input tank 802. As described above, in the modified example, since the MBs generated in the circulating pump 809 are removed or reduced before entering the liquid input tank 802, the MB amount in the UFB-containing liquid supplied from the liquid input tank 802 to the UFB generation unit 804 can be reduced. Thus, the decrease in UFB generation efficiency due to the MBs can be suppressed also in this modified example.

### Fifth Modified Example of Second Embodiment

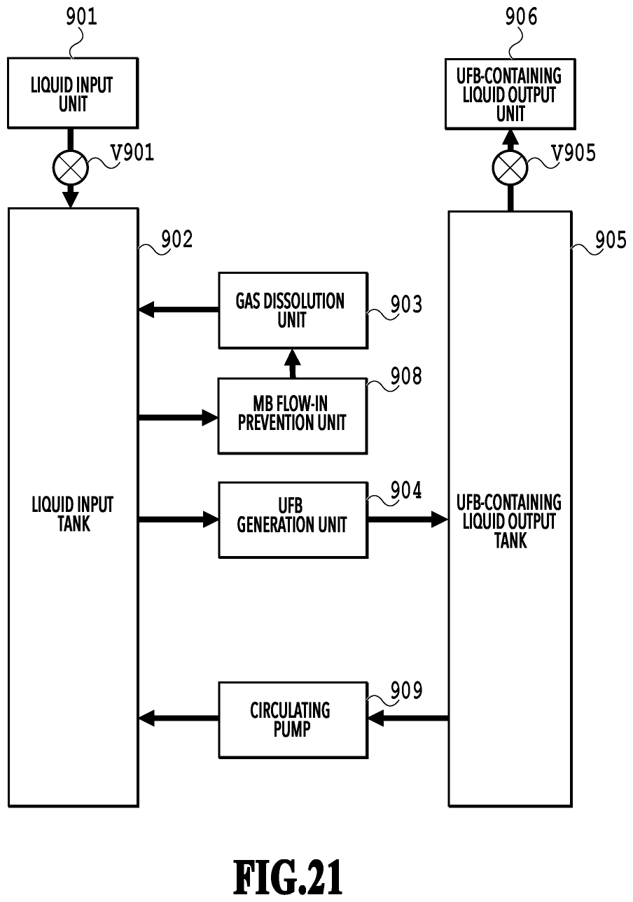

FIG. 21 illustrates a fifth modified example of the second embodiment. In the modified example, the apparatus has a configuration in which an MB flow-in prevention unit 908 is arranged on the liquid flow-in side of a gas dissolution unit 903. More specifically, the apparatus has the following flow passage configuration. A liquid input tank 902 receives the liquid supplied from a liquid input unit 901 and supplies the liquid to the MB flow-in prevention unit 908. The MB flow-in prevention unit 908 produces the MB reduced liquid by removing or isolating the MBs from the supplied liquid and supplies the produced MB reduced liquid to the gas dissolution unit 903. The gas dissolution unit 903 produces the gas-dissolved liquid by dissolving the gas into the supplied liquid and returns the gas-dissolved liquid to the liquid input tank 902.

Moreover, the liquid input tank 902 supplies the gas-dissolved liquid supplied from the gas dissolution unit 903 to a UFB generation unit 904 and the UFB generation unit 904 generates the UFBs in the supplied gas-dissolved liquid and supplies the produced UFB-containing liquid to a UFB-containing liquid output tank 905. The UFB-containing liquid output tank 905 receives the UFB-containing liquid supplied from the UFB generation unit 904 and supplies the UFB-containing liquid to a circulating pump 909. The circulating pump 909 returns the supplied UFB-containing liquid to the liquid input tank 902. Note that this liquid circulation path is formed by closing valves V901 and V905.

According to the modified example, the MBs can be removed or reduced before the MBs accumulated in the liquid input tank 902 flows into the gas dissolution unit 903. Accordingly, it is possible reduce the MB amount in the gas-dissolved liquid supplied to the UFB generation unit 904 and suppress the decrease in UFB generation efficiency due to the MBs.

### Sixth Modified Example of Second Embodiment

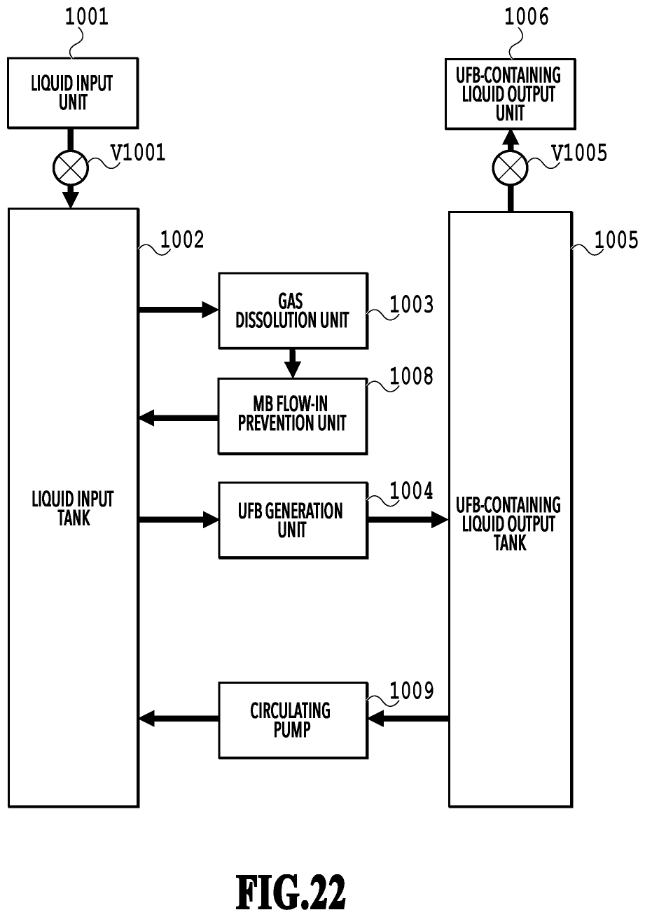

FIG. 22 illustrates a sixth modified example of the second embodiment. In the modified example, the apparatus has a configuration in which an MB flow-in prevention unit 1008 is arranged on the liquid flow-out side of a gas dissolution unit 1003. Specifically, a liquid input tank 1002 receives the liquid supplied from a liquid input unit 1001 and supplies the liquid to the gas dissolution unit 1003. The MB flow-in prevention unit 1008 removes or isolates the MBs from the supplied liquid and returns the gas-dissolved liquid in which the MBs are reduced to the liquid input tank 1002. The liquid input tank 1002 supplies the gas-dissolved liquid in which the MBs are reduced to a UFB generation unit 1004. The UFB generation unit 1004 generates the UFBs in the gas-dissolved liquid in which the MBs are reduced and supplies the generated UFB-containing liquid to a UFB-containing liquid output tank 1005. The UFB-containing liquid output tank 1005 receives the UFB-containing liquid supplied from the UFB generation unit 1004 and supplies the UFB-containing liquid to a circulating pump 1009. The circulating pump 1009 returns the supplied UFB-containing liquid to the liquid input tank 1002. Note that this liquid circulation path is formed by closing valves V1001 and V1005.

As described above, in this modified example, the MB flow-in prevention unit 1008 can remove or reduce the MBs before the MBs contained in the liquid supplied from the gas dissolution unit 1003 enters the liquid input tank 1002. This can reduce the MB amount in the gas-dissolved liquid in the case where the liquid reaches the UFB generation unit 1004 and suppress the decrease in UFB generation efficiency due to the MBs.

### Third Embodiment

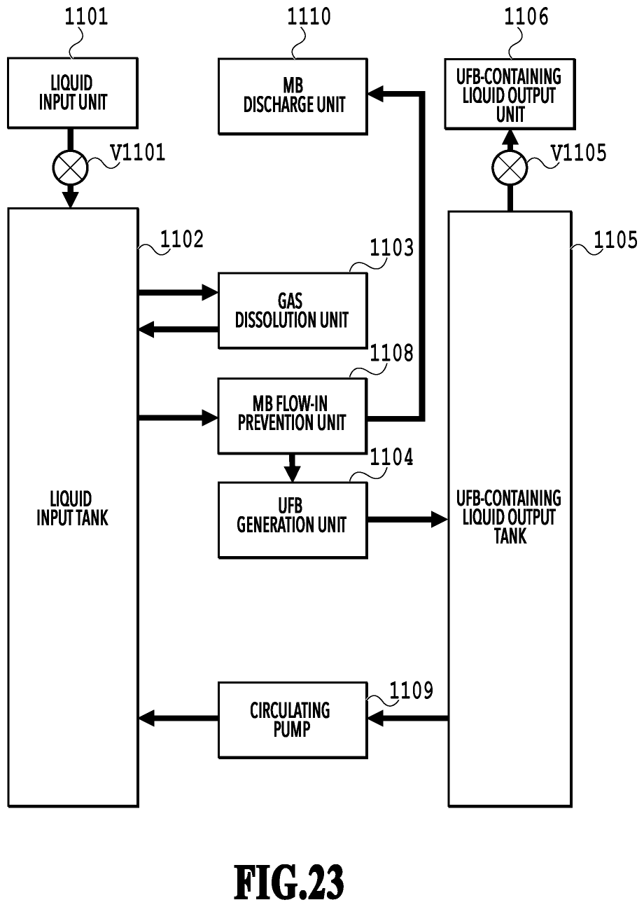

Next, a third embodiment of the present invention is described with reference to FIG. 23. In the embodiment, the apparatus has a configuration in which an MB discharge unit 1110 is connected to an MB flow-in prevention unit 1108 and the MBs accumulated in the MB flow-in prevention unit 1108 are discharged from the MB discharge unit 1110 to the outside. Note that the other configurations are the same as those in the first modified example of the second embodiment. Specifically, a liquid input unit 1101, a liquid input tank 1102, a gas dissolution unit 1103, a UFB generation unit 1104, a UFB-containing liquid output tank 1105, a UFB-containing liquid output unit 1106, and a circulating pump 1109 illustrated in FIG. 23 are the same as 501 to 506 and 509 illustrated in FIG. 17. Accordingly, description of a flow passage configuration formed by these components is omitted and configurations and functions unique to the embodiment are mainly described.

The MB flow-in prevention unit 1108 receives supply of the liquid from the liquid input tank 1102, produces the MB reduction liquid by removing or isolating the MBs, and supplies the produced MB reduced liquid to the UFB generation unit 1104. Accordingly, the UFB generation unit 1104 can efficiently generate the UFBs. Moreover, the MB flow-in prevention unit 1108 has a configuration in which the removed or isolated MBs are sent out to the MB discharge unit 1110. Specifically, the inside of the MB flow-in prevention unit 1108 includes a volume for holding a gas and a volume for holding the UFB-containing liquid or the gas-dissolved liquid supplied from the liquid input tank 1102. Accordingly, an interface between the gas and the liquid is formed in the MB flow-in prevention unit 1108.

The MBs flowing into the MB flow-in prevention unit 1108 together with the gas-dissolved liquid or the UFB-containing liquid float up in the MB flow-in prevention unit 1108 by buoyancy and, upon reaching the gas-liquid interface, come into contact with the atmosphere and disappear. Then, after the MBs disappear at the gas-liquid interface, the gas having formed the MBs is sent to the MB discharge unit 1110 via a gas flow passage. The MB discharge unit 1110 has an atmosphere communication port that communicates with the atmosphere and discharges the gas sent from the MB flow-in prevention unit 1108 from the atmosphere communication port to the outside of the apparatus. A mechanism for discharging the gas may employ, for example, a configuration in which a check valve is provided at the atmosphere communication port and is opened in the case where the pressure in the MB discharge unit 1110 becomes higher than the pressure outside apparatus, to discharge the gas to the outside through the atmosphere communication port.

Configuring the apparatus such that the MBs flowing into the MB flow-in prevention unit 1108 are discharged from the MB discharge unit 1110 as described above can reduce accumulation of the MBs in a filter forming the MB flow-in prevention unit 1108. In the case where many MBs accumulate in the MB flow-in prevention unit 1108, this accumulation causes troubles such as passing of the UFBs hindered in the MB flow-in prevention unit 1108 and the UFBs taken into the MBs in the circulation path. However, in the embodiment, it is possible to suppress the accumulation of the MBs flowing into the MB flow-in prevention unit 1108 and discharge the MBs to the outside as described above. Accordingly, an excellent MB removable performance can be constantly maintained and the flow of the UFBs is not hindered. Thus, the MB reduction liquid in which the MBs are sufficiently reduced is supplied from the MB flow-in prevention unit 1108 to the UFB generation unit 1104 and the UFB generation unit 1104 can efficiently generate the UFBs.

Note that providing the MB flow-in prevention unit 1108 and the MB discharge unit 1110 of the embodiment can be applied to any of the configurations of the aforementioned first and second embodiments and the modified examples thereof.

Moreover, a method of pressurizing the inside of the MB flow-in prevention unit can be employed as the method of preventing accumulation of the MBs in the MB flow-in prevention unit. Specifically, the inside of the MB flow-in prevention unit is pressurized to dissolve the gas forming the MBs in the gas-dissolved liquid or the UFB-containing liquid in the MB flow-in prevention unit by pressurization. This method can suppress the decrease in UFB generation efficiency due to the MBs. Moreover, the dissolution of the gas in the form of MBs by pressurization causes the gas-dissolved liquid with an increased gas dissolution amount to be supplied to the UFB generation unit 1104 and the generation efficiency of the UFBs is further improved. In other words, it is possible to effectively use the MBs included in the MB flow-in prevention unit for the generation of the UFBs and further improve the UFB generation efficiency.

### Fourth Embodiment

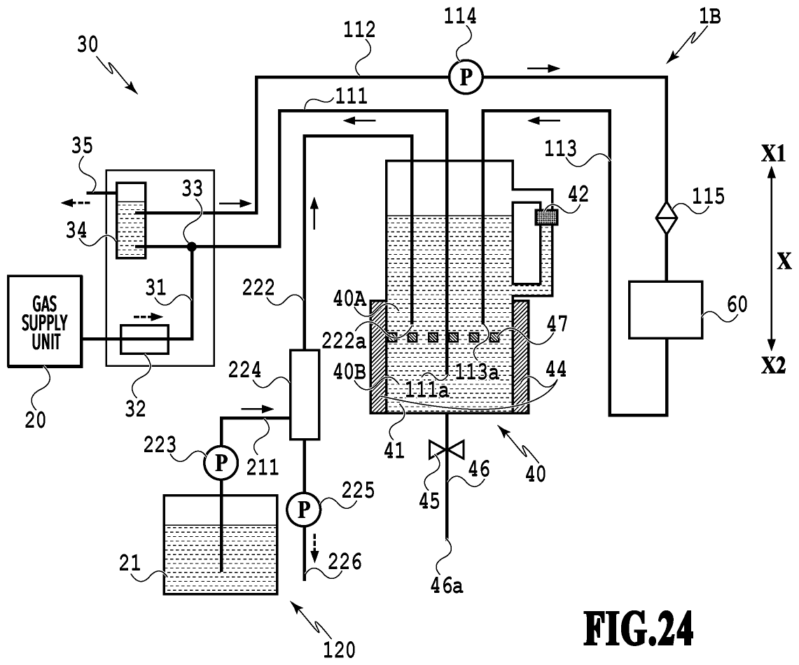

Next, a fourth embodiment of the present invention is described based on FIG. 24. In the embodiment, the apparatus has a configuration in which the liquid input tank and the UFB-containing liquid output tank described in the aforementioned embodiments are integrated. Specific description is given below.

As illustrated in FIG. 24, a UFB-containing liquid production apparatus 1B in the embodiment includes a liquid supply unit 120, a gas supply unit 20, a dissolution unit 30, a first storage chamber 40, and a UFB generation unit 60. Pipes connect these components to one another to allow moving of liquid and gas. The solid line arrows in FIG. 24 illustrate flow of the liquid and the broken line arrows illustrate flow of the gas. Moreover, reference sign X in FIG. 24 denotes the vertical direction. The direction indicated by the arrow X1 is upward in the vertical direction and the direction indicated by the arrow X2 is downward in the vertical direction.

A liquid 21 is stored in the liquid supply unit 120. A pump 223 supplies the liquid 21 to the first storage chamber 40 through a path formed by a pipe 221 and a pipe 222. Moreover, a degassing unit 224 is arranged in the middle of the pipe 222 and removes a dissolution gas existing in the liquid 21. A not-illustrated film through which only the gas can pass is built in the degassing unit 224 and the gas and the liquid are separated from each other by causing the gas to pass through the film. The existing dissolution gas is sucked by a pump 225 and is discharged from a discharge portion 226. Removing the existing dissolution gas in the supplied liquid 21 as described above allows a desired gas to be described later to be dissolved into the liquid 21 as much as possible.

The gas supply unit 20 has a function of supplying the desired gas to be dissolved into the liquid 21. The gas supply unit 20 may be a tank that contains the desired gas, a device that can continuously generate the desired gas, or the like. For example, in the case where the desired gas is oxygen, the gas supply unit 20 may be configured to continuously generate oxygen by taking in the atmospheric air and removing unnecessary nitrogen and to send the generated oxygen with a built-in pump.

The dissolution unit 30 has a function of dissolving the gas supplied from the gas supply unit 20 into a liquid 41 supplied from the first storage chamber 40. Note that a not-illustrated dissolution degree sensor is built in the dissolution unit 30.

The gas supplied from the gas supply unit 20 is subjected to treatment such as electrical discharge in a pretreatment unit 32 and is sent to a dissolution portion 33 through a supply pipe 31. Moreover, the liquid 41 in the first storage chamber 40 is supplied to the dissolution portion 33 through a pipe 111. The gas supplied from the gas supply unit 20 via the pretreatment unit 32 is dissolved into the supplied liquid 41 in the dissolution portion 33. A gas-liquid separation chamber 34 is disposed beyond the dissolution portion 33 and the gas that failed to be dissolved into the dissolution portion 33 is discharged from a discharge portion 35. A pump 114 sends the dissolved liquid to the UFB generation unit 60 through a pipe 112.

The first storage chamber 40 has a function of storing the liquid 41. In detail, the liquid 41 is a mixed liquid of the dissolved liquid into which the gas is dissolved in the dissolution unit 30 and the UFB-containing liquid produced in the UFB generation unit 60. A liquid surface sensor 42 is provided in the first storage chamber 40. In the case where the liquid 21 supplied from the liquid supply unit 120 in an initial state is supplied to the first storage chamber 40 and the liquid surface in the first storage chamber 40 reaches the liquid surface sensor 42, the liquid surface sensor 42 outputs a detection signal to a control unit. The control unit having received the detection signal stops drive of the pump 114 and stops supply of the liquid to the first storage chamber 40.

A cooling unit 44 is arranged around the entire or part of an outer periphery of the first storage chamber 40 and cools the liquid 41. The lower the temperature of the liquid is, the higher the degree of dissolution of the gas can be made. Accordingly, lower liquid temperature is more preferable and the liquid temperature is controlled to be about 10° C. or less by using a not-illustrated temperature sensor.

The cooling unit 44 may have any configuration as long as the liquid 41 can be set at desired temperature and, for example, a cooling device such as a Peltier element or a method of circulating a coolant set to low temperature with a not-illustrated chiller can be employed. In this case, the configuration may be such that a cooling pipe in which the coolant can be circulated is attached by being wound around the outer periphery or such that a container of the first storage chamber 40 has a hollow structure and the coolant passes through a hollow portion. Moreover, the configuration may be such that a cooling pipe passes through the liquid 41. The liquid 41 is thus managed at low temperature and is set to a state where the gas tends to be dissolved. The gas can be thereby efficiently dissolved in the dissolution portion 33.

Moreover, a valve 45 is connected to the first storage chamber 40 and an output pipe 46 in which a liquid output port 46a for taking out the UFB-containing liquid is formed is connected to the valve 45. A not-illustrated concentration sensor that measures the UFB concentration in the liquid 41 is provided in the first storage chamber 40 and the UFB concentration is managed by using the output of the concentration sensor. In the case where the UFB concentration in the liquid 41 reaches a predetermined value, the valve 45 is opened and the UFB-containing liquid 41 is taken out from the liquid output port 46a of the output pipe 46. Although the liquid output port 46a may be arranged at a location other than the first storage chamber 40, the liquid output port 46a is preferably located in a MB reduced region 40B to be described later because the MB concentration in the taken-out UFB-containing liquid is low in this region. Moreover, an agitator or the like may be provided in the first storage chamber 40 to reduce unevenness in the temperature and degree of dissolution in the liquid 41.

The UFB generation unit 60 has a function of generating the UFBs (causing gas phase separation) from the dissolution gas existing in the liquid 41 supplied from the first storage chamber 40. The means of generating the UFBs may be any means such as the Venturi method as long as the UFBs can be generated. In the embodiment, the method of generating the UFBs by applying the film-boiling phenomenon (T-UFB method) is employed to efficiently generate very fine UFBs. In the T-UFB method, film boiling is achieved by causing a heater unit to generate heat. However, since the liquid 41 is set at low temperature of about 10° C. or less as described above, the liquid 41 has a cooling effect on the UFB generation unit 60 and suppresses the temperature rise of the UFB generation unit 60. Thus, a continuous operation for a long period is possible. Note that, in a configuration in which the apparatus has many heaters, there may be case where the heat generation amount is great and merely the contact with the liquid 41 causes temperature rise. In such a case, it is only necessary to add a cooling mechanism to the UFB generation unit 60. The basic configuration described above is preferably employed as a specific configuration.

The pump 114 supplies the liquid 41 from the first storage chamber 40 to the UFB generation unit 60 through the pipe 112. A filter 115 that collects impurities and dust is disposed upstream (on the liquid flow-in side) of the UFB generation unit 60 and suppresses the case where the impurities and dust hinder the generation of the UFBs by the UFB generation unit 60. The UFB-containing liquid containing the UFBs generated in the UFB generation unit 60 passes through a pipe 113 and is collected into the first storage chamber 40.

Note that FIG. 24 illustrates the case where the pump 114 is arranged upstream of the UFB generation unit 60. However, the arrangement of the pump 114 is not limited to this arrangement and can be provided at another location as long as the UFB -containing liquid can be efficiently produced. For example, the pump 114 may be arranged downstream of the UFB generation unit 60. Alternatively, pumps may be arranged both upstream and downstream of the UFB generation unit 60.

An MB flow-in prevention unit 47 is arranged in the first storage chamber 40. The MB flow-in prevention unit 47 divides an inside of the first storage chamber 40 into an MB not-reduced region 40A (region above the MB flow-in prevention unit 47 in the vertical direction) and an MB reduced region 40B (region below the MB flow-in prevention unit 47 in the vertical direction). In this configuration, a liquid outlet port 222a of the liquid supplied from the liquid supply unit 120 and a liquid outlet port 113a of the UFB-containing liquid supplied from the UFB generation unit 60 are arranged in the MB not-reduced region 40A. Moreover, a liquid inlet port 111a to the dissolution unit 30 is arranged in the MB reduced region 40B.

In this configuration, the reentering of the MBs generated in the liquid supply unit 120, the dissolution unit 30, the UFB generation unit 60, and the pumps 114 and 223 to the circulation path is suppressed and the MBs rise in the first storage chamber 40 by buoyancy and eventually disappear by coming into contact with the atmosphere surface. As a result, the MB concentration in the circulation path is reduced and the UFB generation efficiency in the UFB generation unit 60 is improved.

In the apparatus configuration described above, the types of the gas and the liquid are not limited to particular types and can be freely selected. Moreover, the portions that come into contact with the gas and the dissolved liquid (output pipe 46, supply pipe 31, pipes 112, 113, 221, and 222, pumps 114 and 223, filter 115, liquid contact portions of first storage chamber 40 and UFB generation unit 60, and the like) are preferably made of a material with high corrosion resistance. For example, fluoride-based resins such as polytetrafluoroethylene (PTFE) and perfluoroalkoxy alkane (PFA), metals such as SUS 316L, and other inorganic materials are preferably applied to the portions that come into contact with the dissolved liquid. The UFBs can be thereby preferably generated even if a highly-corrosive gas or liquid is used.

Moreover, a pump with small pulsation and flow rate fluctuation is preferably used as the pump 114 to prevent the decrease in UFB generation efficiency. The UFB-containing liquid with small variation in UFB concentration can be thereby efficiently produced.

Next, a UFB generation method in the embodiment is described. As described above, in the UFB-containing liquid production apparatus of the embodiment, the circulation path of the liquid 41 from the first storage chamber 40, to the dissolution unit 30, to the UFB generation unit 60, and to the first storage chamber 40 is formed. In the circulation path, the UFB-containing liquid can be arbitrary circulated in different conditions. In this case, the conditions means a circulation flow rate, pressure in the circulation path, circulation timing, and the like.

For example, in the case where the temperature of the UFB-containing liquid 41 falls to predetermined temperature, first, only the gas supply unit 20 operates and the circulation is performed in a first circulation condition. The first circulation condition is a condition for efficiently dissolving the gas and is a flow rate of about 500 to 3000 mL/min and pressure of about 0.2 to 0.6 MPa. In this case, the UFB generation unit 60 is on the same circulation path as that in which the circulation is performed. Accordingly, if the UFB generation unit 60 employs a method of generating the UFBs by causing the liquid to pass through a portion with a certain shape such as a nozzle, bubbles with unintended sizes may be generated in this step. Meanwhile, in the embodiment, the T-UFB method is employed and, in the T-UFB method, the UFBs are generated by using film-boiling that occurs in the case where a fine heater is driven. Thus, no UFBs are generated unless the heater is driven.

In the case where the degree of dissolution in the liquid 41 reaches the desired degree, the circulation and the gas supply unit 20 are stopped. Then, the UFB-containing liquid is circulated in a second circulation condition and the UFB generation unit 60 is driven. In the embodiment, the second circulation condition is a flow rate of about 30 to 150 mL/min and pressure of about 0.1 to 0.2 MPa. In the T-UFB method, the UFBs are generated by using pressure difference and heat generated in a process from bubble formation by film boiling to disappearance of bubbles. Accordingly, relatively low rate and low pressure (atmospheric pressure) are preferable as the circulation condition.

In the case where the UFB concentration in the liquid 41 reaches the desired UFB concentration, the UFB-containing liquid is taken out. In the take out of the UFB-containing liquid, the UFB-containing liquid in the first storage chamber 40 may be taken out entirely or partially. Then, the aforementioned steps may be repeated until the amount of the UFB-containing liquid reaches a necessary amount.

Performing circulation in the first and second circulation conditions different from each other as described above allows the dissolution of the gas and the generation of the UFBs to be performed in conditions optimal for the respective operations and the high-concentration UFB-containing liquid can be efficiently produced.

Moreover, although the MB flow-in prevention unit 47 is installed in the first storage chamber 40 in FIG. 24, the decrease in UFB generation efficiency due to the MBs can be suppressed without provision of a filter. For example, the liquid outlet port 222a of the liquid supplied from the liquid supply unit 120 and the liquid outlet port 113a of the UFB-containing liquid supplied from the UFB generation unit 60 are arranged above the liquid inlet port 111a of the dissolution unit 30 in the vertical direction. An effect of suppressing the decrease in UFB generation efficiency due to the MBs can be also obtained by this arrangement. This is because the MBs are buoyant and do not move downward in the vertical direction without external force.

Moreover, it is also effective to install the liquid outlet port 222a of the liquid supplied from the liquid supply unit 120 and the liquid outlet port 113a of the UFB-containing liquid supplied from the UFB generation unit 60 such that liquid outlet port 222a and liquid outlet port 113a face upward in the vertical direction.

Although the embodiment achieves a particularly great effect in combination with the T-UFB, a similar effect can be expected to be obtained also in conventional UFB generation methods such as the existing Venturi method and fine bubble injection method.

The efficiency of removing the MBs in the MB flow-in prevention unit 47 can be further improved by the following method.

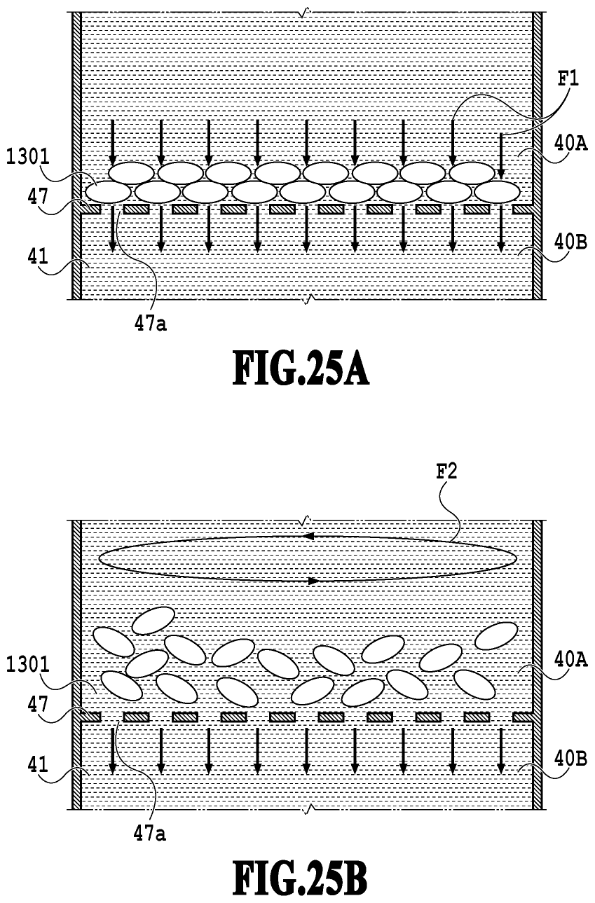

FIGS. 25A and 25B are explanatory views illustrating a state of the MBs in the first storage chamber 40 in FIG. 24. Since the liquid 41, the MB flow-in prevention unit 47, the MB not-reduced region 40A, and the MB reduced region 40B illustrated in FIGS. 25A and 25B are the same as those illustrated in FIG. 24, description thereof is omitted. Note that reference numeral 1301 in FIGS. 25A and 25B denotes the MBs.

FIG. 25A illustrates a state of the MBs in the case where a flow F1 of the liquid 41 in the MB not-reduced region 40A of the first storage chamber 40 is mainly orthogonal to the MB flow-in prevention unit 47 formed of the filter. In the example illustrated in FIG. 25A, the MBs 1301 contained in the liquid (gas-dissolved liquid) flowing into the MB flow-in prevention unit 47 are caught by the MB flow-in prevention unit 47 and are gradually stacked on a surface of the MB flow-in prevention unit 47 on the liquid flow-in side. In such a state, there is the following concern: the MBs 1301 block filter holes (liquid flow holes) 47a of the MB flow-in prevention unit 47 and the flow rate of the liquid toward the MB reduced region 40B decreases; the MB flow-in prevention unit 47 thereby causes the circulation rate of the liquid in the entire apparatus to decrease.

Accordingly, a not-illustrated agitator agitates the liquid in the first storage chamber 40, particularly the liquid in the MB not-reduced region 40A to form, for example, a flow of liquid as illustrated by the arrows F2 in FIG. 25B. In the example illustrated in FIG. 25B, the flow of the liquid in the MB not-reduced region 40A is present in a manner mainly parallel to the MB flow-in prevention unit 47. Forming such a flow of liquid causes the MBs 1301 to circulate in the MB not-reduced region 40A and the MBs 1301 are less likely to be stacked on the MB flow-in prevention unit 47. As a result, a ratio of the filter holes 47a of the MB flow-in prevention unit 47 blocked by the MBs decreases and the decrease in the circulation rate in the entire apparatus can be reduced.

Moreover, it is effective to make the flow passage cross-sectional area of the MB reduced region 40B smaller than the flow passage cross-sectional area of the MB not-reduced region 40A to increase the flow rate in the MB reduced region 40B. In this case, using the flow-rate increase effect in the MB reduced region 40B in addition to the aforementioned agitation effect can further reduce the decrease in the circulation rate in the entire apparatus.

Although the example in which the flow direction of the liquid by the agitation is parallel to the MB flow-in prevention unit 47 is illustrated in FIG. 25B, the the flow direction of the liquid formed by the agitation of the liquid does not have to be parallel to the MB flow-in prevention unit 47. The decrease in the circulation rate in the entire apparatus can be suppressed as long as the flow of the liquid can be generated in such a direction that a component in the direction parallel to the MB flow-in prevention unit 47 is greater than that in the case where no agitation is performed.

The greater the amount of MBs flowing into the first storage chamber 40 is, the higher the possibility that the MBs deposit on the MB flow-in prevention unit 47 and reduce the circulation rate in the entire apparatus is. However, in the case where the T-UFB generation method is employed as the UFB generation method of the UFB generation unit, almost no MBs are generated in the UFB generation. Accordingly, the amount of MBs flowing into the first storage chamber 40 is smaller than those in the case where the other UFB generation methods are used. Thus, in the case where the UFBs are generated by using the T-UFB generation method, the decrease in the circulation rate caused by the deposition of the MBs on the MB flow-in prevention unit 47 is less likely to occur and the effect of the MB flow-in prevention unit 47 can be stably obtained for a long period. Thus, the aforementioned method of suppressing the deposition of the MBs in the MB flow-in prevention unit 47 is particularly effective in the case where the UFB generation methods other than the T-UFB generation method are employed.

As described above, according to the embodiments of the present invention, the MB flow-in prevention unit reduces the flow-in of the MBs into the UFB generation unit and this can suppress the decrease in the UFB generation efficiency in the UFB generation unit and enables production of the UFB-containing liquid with a high UFB concentration and high UFB purity.

### «Liquid and Gas Usable For T-UFB-Containing Liquid»

Now, the liquid W usable for generating the T-UFB-containing liquid is described. The liquid W usable in this embodiment is, for example, pure water, ion exchange water, distilled water, bioactive water, magnetic active water, lotion, tap water, sea water, river water, clean and sewage water, lake water, underground water, rain water, and so on. A mixed liquid containing the above liquid and the like is also usable. A mixed solvent containing water and soluble organic solvent can be also used. The soluble organic solvent to be used by being mixed with water is not particularly limited; however, the followings can be a specific example thereof. An alkyl alcohol group of the carbon number of 1 to 4 including methyl alcohol, ethyl alcohol, n-propyl alcohol, isopropyl alcohol, n-butyl alcohol, sec-butyl alcohol, and tert-butyl alcohol. An amide group including N-methyl-2-pyrrolidone, 2-pyrrolidone, 1,3-dimethyl-2-imidazolidinone, N,N-dimethylformamide, and N,N-dimethylacetamide. A keton group or a ketoalcohol group including acetone and diacetone alcohol. A cyclic ether group including tetrahydrofuran and dioxane. A glycol group including ethylene glycol, 1,2-propylene glycol, 1,3-propylene glycol, 1,2-butanediol, 1,3-butanediol, 1,4-butanediol, 1,5-pentanediol, 1,2-hexanediol, 1,6-hexanediol, 3-methyl-1,5-pentanediol, diethylene glycol, triethylene glycol, and thiodiglycol. A group of lower alkyl ether of polyhydric alcohol including ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, and triethylene glycol monobutyl ether. A polyalkylene glycol group including polyethylene glycol and polypropylene glycol. A triol group including glycerin, 1,2,6-hexanetriol, and trimethylolpropane. These soluble organic solvents can be used individually, or two or more of them can be used together.

A gas component that can be introduced into the dissolving unit 200 is, for example, hydrogen, helium, oxygen, nitrogen, methane, fluorine, neon, carbon dioxide, ozone, argon, chlorine, ethane, propane, air, and so on. The gas component may be a mixed gas containing some of the above. Additionally, it is not necessary for the dissolving unit 200 to dissolve a substance in a gas state, and the dissolving unit 200 may fuse a liquid or a solid containing desired components into the liquid W. The dissolution in this case may be spontaneous dissolution, dissolution caused by pressure application, or dissolution caused by hydration, ionization, and chemical reaction due to electrolytic dissociation.

### «Effects of T-UFB Generating Method»

Next, the characteristics and the effects of the above-described T-UFB generating method are described by comparing with a conventional UFB generating method. For example, in a conventional air bubble generating apparatus as represented by the Venturi method, a mechanical depressurizing structure such as a depressurizing nozzle is provided in a part of a flow passage. A liquid flows at a predetermined pressure to pass through the depressurizing structure, and air bubbles of various sizes are generated in a downstream region of the depressurizing structure.

In this case, among the generated air bubbles, since the relatively large bubbles such as milli-bubbles and microbubbles are affected by the buoyancy, such bubbles rise to the liquid surface and disappear. Even the UFBs that are not affected by the buoyancy may also disappear with the milli-bubbles and microbubbles since the gas-liquid interface energy of the UFBs is not very large. Additionally, even if the above-described depressurizing structures are arranged in series, and the same liquid flows through the depressurizing structures repeatedly, it is impossible to store for a long time the UFBs of the number corresponding to the number of repetitions. In other words, it has been difficult for the UFB-containing liquid generated by the conventional UFB generating method to maintain the concentration of the contained UFBs at a predetermined value for a long time.

In contrast, in the T-UFB generating method of this embodiment utilizing the film boiling, a rapid temperature change from normal temperature to about 300° C. and a rapid pressure change from normal pressure to around a several megapascal occur locally in a part extremely close to the heating element. The heating element is a rectangular shape having one side of around several tens to hundreds of μm. It is around 1/10 to 1/1000 of the size of a conventional UFB generating unit. Additionally, with the gas-dissolved liquid within the extremely thin film region of the film boiling bubble surface exceeding the thermal dissolution limit or the pressure dissolution limit instantaneously (in an extremely short time under microseconds), the phase transition occurs and the gas-dissolved liquid is precipitated as the UFBs. In this case, the relatively large bubbles such as milli-bubbles and microbubbles are hardly generated, and the liquid contains the UFBs of about 100 nm in diameter with extremely high purity. Moreover, since the T-UFBs generated in this way have sufficiently large gas-liquid interface energy, the T-UFBs are not broken easily under the normal environment and can be stored for a long time.

Particularly, the present invention using the film boiling phenomenon that enables local formation of a gas interface in the liquid can form an interface in a part of the liquid close to the heating element without affecting the entire liquid region, and a region on which the thermal and pressure actions performed can be extremely local. As a result, it is possible to stably generate desired UFBs. With further more conditions for generating the UFBs applied to the generation liquid through the liquid circulation, it is possible to additionally generate new UFBs with small effects on the already-made UFBs. As a result, it is possible to produce a UFB liquid of a desired size and concentration relatively easily.

Moreover, since the T-UFB generating method has the above-described hysteresis properties, it is possible to increase the concentration to a desired concentration while keeping the high purity. In other words, according to the T-UFB generating method, it is possible to efficiently generate a long-time storable UFB-containing liquid with high purity and high concentration.

### «Specific Usage of T-UFB-Containing Liquid»

In general, applications of the ultrafine bubble-containing liquids are distinguished by the type of the containing gas. Any type of gas can make the UFBs as long as an amount of around PPM to BPM of the gas can be dissolved in the liquid. For example, the ultrafine bubble-containing liquids can be applied to the following applications.

A UFB-containing liquid containing air can be preferably applied to cleansing in the industrial, agricultural and fishery, and medical scenes and the like, and to cultivation of plants and agricultural and fishery products.

A UFB-containing liquid containing ozone can be preferably applied to not only cleansing application in the industrial, agricultural and fishery, and medical scenes and the like, but to also applications intended to disinfection, sterilization, and decontamination, and environmental cleanup of drainage and contaminated soil, for example.

A UFB-containing liquid containing nitrogen can be preferably applied to not only cleansing application in the industrial, agricultural and fishery, and medical scenes and the like, but to also applications intended to disinfection, sterilization, and decontamination, and environmental cleanup of drainage and contaminated soil, for example.

A UFB-containing liquid containing oxygen can be preferably applied to cleansing application in the industrial, agricultural and fishery, and medical scenes and the like, and to cultivation of plants and agricultural and fishery products.

A UFB-containing liquid containing carbon dioxide can be preferably applied to not only cleansing application in the industrial, agricultural and fishery, and medical scenes and the like, but to also applications intended to disinfection, sterilization, and decontamination, for example.

A UFB-containing liquid containing perfluorocarbons as a medical gas can be preferably applied to ultrasonic diagnosis and treatment. As described above, the UFB-containing liquids can exert the effects in various fields of medical, chemical, dental, food, industrial, agricultural and fishery, and so on.

In each of the applications, the purity and the concentration of the UFBs contained in the UFB-containing liquid are important for quickly and reliably exert the effect of the UFB-containing liquid. In other words, unprecedented effects can be expected in various fields by utilizing the T-UFB generating method of this embodiment that enables generation of the UFB-containing liquid with high purity and desired concentration. Here is below a list of the applications in which the T-UFB generating method and the T-UFB-containing liquid are expected to be preferably applicable.

### (A) Liquid Purification Application

With the T-UFB generating unit provided to a water clarification unit, enhancement of an effect of water clarification and an effect of purification of PH adjustment liquid is expected. The T-UFB generating unit may also be provided to a carbonated water server.

With the T-UFB generating unit provided to a humidifier, aroma diffuser, coffee maker, and the like, enhancement of a humidifying effect, a deodorant effect, and a scent spreading effect in a room is expected.

If the UFB-containing liquid in which an ozone gas is dissolved by the dissolving unit is generated and is used for dental treatment, burn treatment, and wound treatment using an endoscope, enhancement of a medical cleansing effect and an antiseptic effect is expected.

With the T-UFB generating unit provided to a water storage tank of a condominium, enhancement of a water clarification effect and chlorine removing effect of drinking water to be stored for a long time is expected.

If the T-UFB-containing liquid containing ozone or carbon dioxide is used for brewing process of Japanese sake, shochu, wine, and so on in which the high-temperature pasteurization processing cannot be performed, more efficient pasteurization processing than that with the conventional liquid is expected.

If the UFB-containing liquid is mixed into the ingredient in a production process of the foods for specified health use and the foods with functional claims, the pasteurization processing is possible, and thus it is possible to provide safe and functional foods without a loss of flavor.

With the T-UFB generating unit provided to a supplying route of sea water and fresh water for cultivation in a cultivation place of fishery products such as fish and pearl, prompting of spawning and growing of the fishery products is expected.

With the T-UFB generating unit provided in a purification process of water for food preservation, enhancement of the preservation state of the food is expected.

With the T-UFB generating unit provided in a bleaching unit for bleaching pool water or underground water, a higher bleaching effect is expected.

With the T-UFB-containing liquid used for repairing a crack of a concrete member, enhancement of the effect of crack repairment is expected.

With the T-UFBs contained in liquid fuel for a machine using liquid fuel (such as automobile, vessel, and airplane), enhancement of energy efficiency of the fuel is expected.

### (B) Cleansing Application

Recently, the UFB-containing liquids have been receiving attention as cleansing water for removing soils and the like attached to clothing. If the T-UFB generating unit described in the above embodiment is provided to a washing machine, and the UFB-containing liquid with higher purity and better permeability than the conventional liquid is supplied to the washing tub, further enhancement of detergency is expected.

With the T-UFB generating unit provided to a bath shower and a bedpan washer, not only a cleansing effect on all kinds of animals including human body but also an effect of prompting contamination removal of a water stain and a mold on a bathroom and a bedpan are expected.

With the T-UFB generating unit provided to a window washer for automobiles, a high-pressure washer for cleansing wall members and the like, a car washer, a dishwasher, a food washer, and the like, further enhancement of the cleansing effects thereof is expected.

With the T-UFB-containing liquid used for cleansing and maintenance of parts produced in a factory including a burring step after pressing, enhancement of the cleansing effect is expected.

In production of semiconductor elements, if the T-UFB-containing liquid is used as polishing water for a wafer, enhancement of the polishing effect is expected. Additionally, if the T-UFB-containing liquid is used in a resist removal step, prompting of peeling of resist that is not peeled off easily is enhanced.

With the T-UFB generating unit is provided to machines for cleansing and decontaminating medical machines such as a medical robot, a dental treatment unit, an organ preservation container, and the like, enhancement of the cleansing effect and the decontamination effect of the machines is expected. The T-UFB generating unit is also applicable to treatment of animals.

### (C) Pharmaceutical Application

If the T-UFB-containing liquid is contained in cosmetics and the like, permeation into subcutaneous cells is prompted, and additives that give bad effects to skin such as preservative and surfactant can be reduced greatly. As a result, it is possible to provide safer and more functional cosmetics.

If a high concentration nanobubble preparation containing the T-UFBs is used for contrasts for medical examination apparatuses such as a CT and an MRI, reflected light of X-rays and ultrasonic waves can be efficiently used. This makes it possible to capture a more detailed image that is usable for initial diagnosis of a cancer and the like.

If a high concentration nanobubble water containing the T-UFBs is used for a ultrasonic wave treatment machine called high-intensity focused ultrasound (HIFU), the irradiation power of ultrasonic waves can be reduced, and thus the treatment can be made more non-invasive. Particularly, it is possible to reduce the damage to normal tissues.

It is possible to create a nanobubble preparation by using high concentration nanobubbles containing the T-UFBs as a source, modifying a phospholipid forming a liposome in a negative electric charge region around the air bubble, and applying various medical substances (such as DNA and RNA) through the phospholipid.

If a drug containing high concentration nanobubble water made by the T-UFB generation is transferred into a dental canal for regenerative treatment of pulp and dentine, the drug enters deeply a dentinal tubule by the permeation effect of the nanobubble water, and the decontamination effect is prompted. This makes it possible to treat the infected root canal of the pulp safely in a short time.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-021424 filed Feb. 12, 2020, which is hereby incorporated by reference wherein in its entirety.

What is claimed is:

1. A UFB -containing liquid production apparatus comprising:
a gas dissolution unit that produces a gas-dissolved liquid by dissolving a gas into a liquid supplied from a liquid supply unit;
a UFB generation unit that generates UFBs in the gas-dissolved liquid flowing into the UFB generation unit;
a circulation path that supplies the gas-dissolved liquid produced by the gas dissolution unit to the UFB generation unit and supplies a UFB-containing liquid produced by the UFB generation unit to the liquid supply unit; and
a micro-bubble reduction unit that is provided in the circulation path and that reduces an amount of micro-bubbles contained in the gas-dissolved liquid to flow into the UFB generation unit.

2. The UFB-containing liquid production apparatus according to claim 1, wherein the micro-bubble reduction unit is provided on at least one of the liquid flow-in side and the liquid flow-out side of the UFB generation unit.

3. The UFB-containing liquid production apparatus according to claim 2, wherein
the micro-bubble reduction unit is provided on the liquid flow-in side of the UFB generation unit, and
the UFB generation unit supplies the UFB-containing liquid produced in the UFB generation unit to the liquid supply unit.

4. The UFB-containing liquid production apparatus according to claim 2, wherein
the micro-bubble reduction unit is provided on the liquid flow-out side of the UFB generation unit, and
the UFB-containing liquid produced in the UFB generation unit is supplied to the liquid supply unit via the micro-bubble reduction unit.

5. The UFB-containing liquid production apparatus according to claim 4, wherein the micro-bubble reduction unit is provided on the liquid flow-out side of a pump that circulates the liquid in the circulation path.

6. The UFB-containing liquid production apparatus according to claim 1, wherein the gas dissolution unit produces the gas-dissolved liquid obtained by dissolving the gas into the liquid supplied from the liquid supply unit, and then supplies the produced gas-dissolved liquid to the liquid supply unit.

7. The UFB-containing liquid production apparatus according to claim 6, wherein the micro-bubble reduction unit is provided between the liquid flow-out side of the gas dissolution unit and the liquid flow-in side of the liquid supply unit.

8. The UFB-containing liquid production apparatus according to claim 6, wherein the micro-bubble reduction unit is provided between the liquid flow-in side of the gas dissolution unit and the liquid flow-out side of the liquid supply unit.

9. The UFB-containing liquid production apparatus according to claim 1, further comprising a liquid collection unit that collects the UFB-containing liquid produced by the UFB generation unit and then supplies the collected UFB-containing liquid to a predetermined liquid output unit.

10. The UFB-containing liquid production apparatus according to claim 1, wherein
at least one of a liquid outlet port of the liquid supply unit and a liquid outlet port of the UFB generation unit is provided in a container provided with a liquid inlet port of the gas dissolution unit, and
the at least one of the liquid outlet port of liquid supply unit and the liquid outlet port of the UFB generation unit provided in the container is located above the liquid inlet port of the gas dissolution unit in a vertical direction.

11. The UFB-containing liquid production apparatus according to claim 1, wherein
the container is provided with a liquid output port from which the liquid is outputted, and
the at least one of the liquid outlet port of liquid supply unit and the liquid outlet port of the UFB generation unit provided in the container is located above the liquid output port of the container in the vertical direction.

12. The UFB-containing liquid production apparatus according to claim 1, wherein the micro-bubble reduction unit includes a discharge unit that discharges a gas accumulated in the micro-bubble reduction unit.

13. The UFB-containing liquid production apparatus according to claim 1, wherein the micro-bubble reduction unit is configured to include a filter that does not allow micro-bubbles to pass and allows UFBs to pass.

14. The UFB-containing liquid production apparatus according to claim 1, further comprising an agitation unit that agitates the liquid present in a region on the micro-bubble flow-in side of the filter.

15. The UFB-containing liquid production apparatus according to claim 1, wherein the micro-bubble reduction unit has a configuration that causes the micro-bubbles to float by buoyancy and come into contact with the atmosphere to disappear.

16. A UFB-containing liquid production method comprising:
causing a gas dissolution unit to produce a gas-dissolved liquid by dissolving a gas into a liquid supplied from a liquid supply unit;
causing a UFB generation unit to generate UFBs in the gas-dissolved liquid;
supplying a UFB-containing liquid produced by the UFB generation unit to the liquid supply unit through a circulation path;
causing a micro-bubble reduction unit provided in the circulation path to reduce an amount of micro-bubbles contained in the gas-dissolved liquid to flow into the UFB generation unit.
